(19) United States
(12) Patent Application Publication
(10) Pub. No.: US 2024/0394730 A1
(43) Pub. Date: Nov. 28, 2024

(54) USER-CONTRIBUTOR RANKING AND MATCHING IN A CONTENT MARKETPLACE

(71) Applicant: Shutterstock, Inc., New York, NY (US)

(72) Inventors: Raúl Gómez, Dublin (IE); Alessandra Sala, Dublin (IE)

(21) Appl. No.: 18/324,408

(22) Filed: May 26, 2023

(51) Int. Cl. G06Q 30/0201; G06Q 30/018; G06Q 30/0601

(52) U.S. Cl. CPC G06Q 30/0201; G06Q 30/018; G06Q 30/0601

(57) ABSTRACT

A method for providing contributor recommendations to users of an online content marketplace is provided. The method includes retrieving an attribute of a user of an online content marketplace, identifying contributors of the online content marketplace based on the attribute of the user, scoring user-contributor pairs according to a dense embedding of the attribute of the user and a dense embedding for each of the contributors, providing, to the user, a list of the contributors ranked according to the score of the user-contributor pairs, receiving, from the user, a contributor selection, and providing, to the user, multiple content files from a gallery of the selected contributor, for use in a media application running on a client device with the first user. A system including a memory storing instructions and a processor to execute the instructions to cause the system to perform the above method are also provided.

### BACKGROUND

### Field

The present disclosure generally relates to providing contributor recommendations to users of a design platform in a content marketplace. More specifically, the present disclosure relates to matching users and contributors in the content marketplace according to past history, user and contributor attributes, ranking the user-contributor pairing, and providing a user recommendation to download a contributor's content accordingly.

### Description of the Related Art

Users (creatives) of a graphic design platform supported by an online content marketplace often receive content recommendations for a given design, wherein the content has been uploaded to the marketplace by other contributors (which are creatives in the online content marketplace as well). The recommendations are typically based on the most frequently downloaded content. The result is that most content downloads are made from a selected group of creatives, which tends to limit the variety of a design platform and hinder its ability to evolve and broaden market base and results in repetitive themes and styles in graphic design.

### SUMMARY

In a first embodiment, a computer-implemented method includes retrieving an attribute of a first user of an online content marketplace, identifying a one or more contributors of the online content marketplace, based on the attribute of the first user, scoring multiple pairs of the first user with each of the one or more contributors according to a dense vector embedding of the attribute of the first user and a dense vector embedding for each of the one or more contributors, providing, to the first user of the online content marketplace, a list of the one or more contributors ranked according to the scoring of the pairs of the first user with each of the one or more contributors, receiving, from the first user, a selected contributor from the one or more contributors, and providing, to the first user, multiple content files from a gallery of the selected contributor for use in a media application running on a client device with the first user.

In a second embodiment, a system includes a memory storing multiple instructions, and one or more processors configured to execute the instructions to cause the system to perform operations. The operations include to: retrieve an attribute of a first user of an online content marketplace, identify a one or more contributors of the online content marketplace, based on the attribute of the first user, score multiple pairs of the first user with each of the one or more contributors, according to a dense vector embedding of the attribute of the first user and a dense vector embedding for each of the one or more contributors, provide, to the first user of the online content marketplace, a list of the one or more contributors, ranked according to a score of the pairs of the first user with each of the one or more contributors, receive, from the first user, a selected contributor from the one or more contributors, and provide, to the first user, multiple content files from a gallery of the selected contributor for use in a media application running on a client device with the first user.

In a third embodiment, a method for training a model for recommending contributors to users of an online content marketplace includes: selecting a first creative and a second creative from a subscriber list to the online content marketplace, forming a first sparse vector from a one or more attributes of the first creative and a second sparse vector from a one or more attributes of the second creative, convolving a one or more coordinates of the first sparse vector into a dense user vector having fewer dimensions than the first sparse vector, convolving a one or more coordinates of the second sparse vector into a dense contributor vector having a same dimension as the dense user vector, finding a first distance between the dense user vector and the dense contributor vector, scoring a user-contributor pair based on the first distance and a distance between the dense user vector and a random dense contributor vector, and increasing a score of the user-contributor pair for each content file from the second creative that is selected by the first creative.

In yet another embodiment, a system includes a first means to store instructions and a second means to execute the instructions and cause the system to perform a method. The method includes retrieving an attribute of a first user of an online content marketplace, identifying a one or more contributors of the online content marketplace, based on the attribute of the first user, scoring multiple pairs of the first user with each of the one or more contributors according to a dense vector embedding of the attribute of the first user and a dense vector embedding for each of the one or more contributors, providing, to the first user of the online content marketplace, a list of the one or more contributors ranked according to the scoring of the pairs of the first user with each of the one or more contributors, receiving, from the first user, a selected contributor from the one or more contributors, and providing, to the first user, multiple content files from a gallery of the selected contributor for use in a media application running on a client device with the first user.

It is understood that other configurations of the subject technology will become readily apparent to those skilled in the art from the following detailed description.

### BRIEF DESCRIPTION OF THE FIGURES

FIG. 1 illustrates an example architecture for matching creatives in a content marketplace, according to some embodiments.

FIG. 2 is a block diagram illustrating detailed components and devices in the architecture of FIG. 1, according to some embodiments.

FIG. 3 illustrates a schematic diagram of contributors recommended to users based on nationality attributes, according to some embodiments.

FIGS. 4A-4B illustrate statistical information indicative of a population of users and contributors selected for training a model for user-contributor ranking and matching, according to some embodiments.

FIGS. 5A-5B illustrate neural network architectures for generating a model for user-contributor ranking and matching, according to some embodiments.

FIGS. 6A-6E illustrate different user-contributor pairings including some of the recent licensed content for each, and the ranking of the pair by the model, according to some embodiments.

FIGS. 7A-7D illustrate different user-contributor pairings having a high-ranking score in the model, according to some embodiments.

FIGS. 8A-8D illustrate statistical information indicative of the diversity in contributor recommendations to users based on a ranking and matching model, according to some embodiments.

FIGS. 9A-9D illustrate user lease history and top-ranking contributor recommendations provided by a ranking and matching model, according to some embodiments.

FIGS. 10A-10B illustrate different views of a graphic design application hosted by a creative machine engine that enables user-contributor interactions, according to some embodiments.

FIG. 11 is a flowchart illustrating steps in a method for matching creatives in a content marketplace, according to some embodiments.

FIG. 12 is a flow chart illustrating steps in a method for training a neural network to rank user-contributor pairs in a content marketplace, according to some embodiments.

FIG. 13 is a block diagram illustrating an example computer system with which the client and server of FIGS. 1 and 2 and the methods of FIGS. 11-12 can be implemented, according to some embodiments.

In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

As used herein, the term “content” may be used, for example, in reference to a media file or digital file that is composed of one or more media elements of different types (text, image, video, audio, and the like). A content or media file can be a single picture, a single video file, an audio file, or any combination of the above. While most of the examples and illustrations in this disclosure will include content filed that are images, for illustration simplicity, it should be understood that the users/contributors, and creatives may handle audio/music files and videos, or any combination of audio, video, and still images or photography.

### General Overview

An online content marketplace is a platform where creatives (contributors) upload content to be licensed by other creatives (users). While the content catalog may be large and diverse, creatives tend to be focused on a small domain of topics and interests, and therefore matching users to contributors with similar interests becomes key to the success of an online content marketplace that benefits from user-contributor content licensing. Accordingly, a creative matching engine as disclosed herein includes a ranking tool which is a model that learns user-contributor synergies based on their licensing history and other attributes. In some embodiments, the ranking tool boosts unpopular, lesser known, or new contributors in the recommendations, balancing as a result the concentration of licenses in a few popular contributors existing in the marketplace and represented in the training data.

Recommendations in a content marketplace have the peculiarity of consisting in matching creatives' work to creatives' needs. Some online marketplaces have a large pool of contributors that upload content to the platform, which constitutes a large and diverse catalog in the service of users who are content creators themselves. A challenging particularity of creatives as users is that they are not the final content consumers and their interests, linked to the projects they work on, change rapidly and abruptly. In some embodiments, an online marketplace may model long term visual style preferences of a creative, to personalize search results. In this disclosure, a model learns users' and contributors' synergies from their licensing history, effectively matching creatives (users) to creatives (contributors) with a special focus on boosting licenses from contributors that are less popular or new, in the platform.

### Example System Architecture

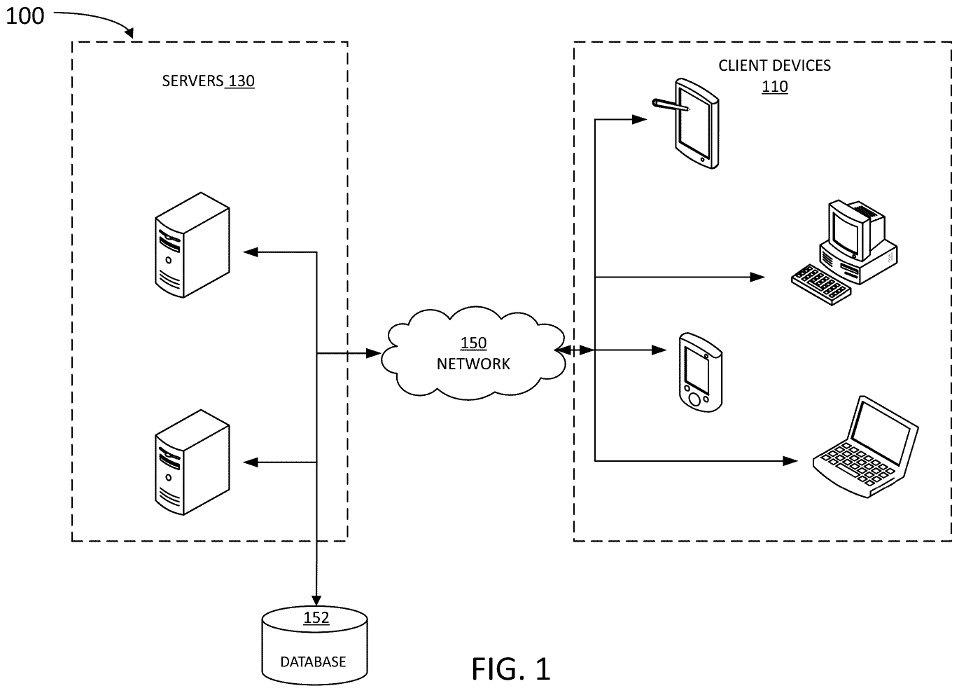

FIG. 1 illustrates an example architecture 100 for matching creatives in an online content marketplace, according to some embodiments. Architecture 100 includes servers 130 communicatively coupled with client devices 110 over a network 150. One of the many servers 130 is configured to host a memory including instructions which, when executed by a processor, cause the server 130 to perform at least some of the steps in methods as disclosed herein. In some embodiments, the processor is configured to manage a creative project upon request by the user of one of client devices 110. The creative project may include a multimedia advertising campaign, a movie or movie clip, a website launch, a musical composition, artistic development, or any other graphic design project. Accordingly, the processor may include a content marketplace engine with a search tool, configured to search for content in a database 152, and a license tool, for users to download content from database 152. Servers 130 may also include a creative matching engine configured to provide recommendations lists of contributors to users of the online content marketplace. For purposes of load balancing, multiple servers 130 can host memories including instructions to one or more processors, and multiple servers 130 can host a history log and the second image database. Moreover, the creative project may be a collaborative project involving multiple users working for a design agency, having client devices 110 accessing one or more servers 130 where one or more project documents are stored. Client devices 110 may communicate with each other via network 150 and through access to server 130 and resources located therein.

Servers 130 may include any device having an appropriate processor, memory, and communications capability for hosting the search engine including multiple tools associated with it. The search engine may be accessible by various clients 110 over network 150. Clients 110 can be, for example, desktop computers, mobile computers, tablet computers (e.g., including e-book readers), mobile devices (e.g., a smartphone or PDA), or any other devices having appropriate processor, memory, and communications capabilities for accessing the search engine on one or more of servers 130. Network 150 can include, for example, any one or more of a local area network (LAN), a wide area network (WAN), the Internet, and the like. Further, network 150 can include, but is not limited to, any one or more of the following tool topologies, including a bus network, a star network, a ring network, a mesh network, a star-bus network, tree or hierarchical network, and the like.

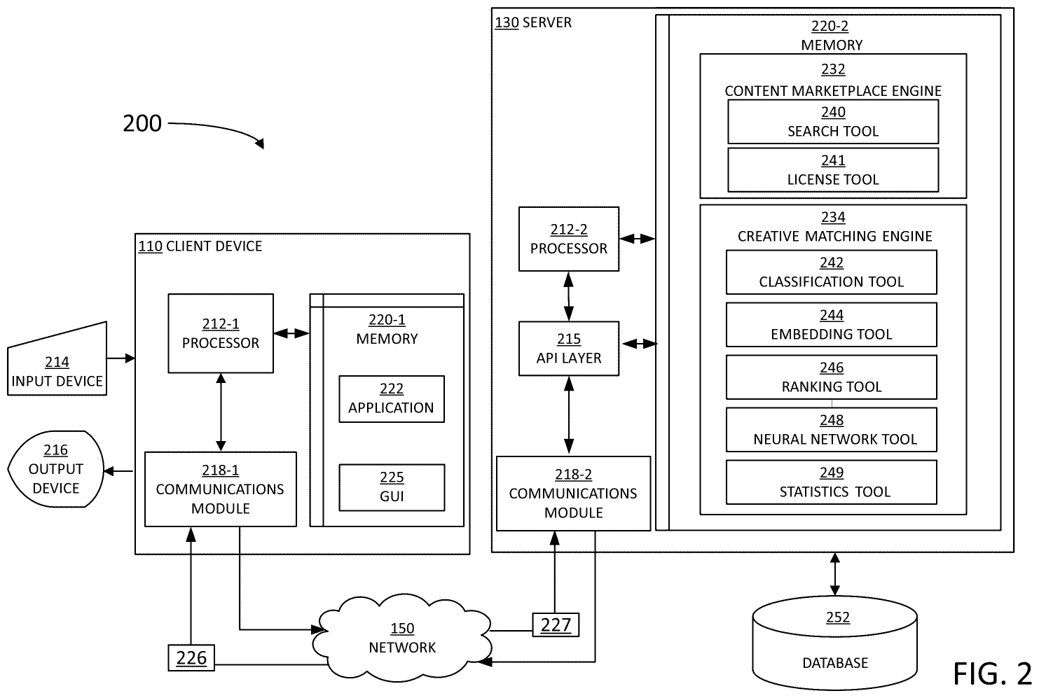

FIG. 2 is a block diagram 200 illustrating an example server 130 and client device 110 from the architecture of FIG. 1, according to some embodiments. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices on the network. Communications modules 218 can be, for example, modems or Ethernet cards. A user may interact with client device 110 via an input device 214 and an output device 216. Input device 214 may include a mouse, a keyboard, a pointer, a touchscreen, a microphone, and the like. Output device 216 may be a screen display, a touchscreen, a speaker, and the like. Client device 110 may include a memory 220-1 and a processor 212-1. Memory 220-1 may include an application 222, configured to run in client device 110. Application 222 may be a graphic design application downloaded by the user from server 130 and may be hosted by server 130. Server 130 may transmit a dataset 226 to client device 110, wherein dataset 226 may include a recommended media file for including in a graphic design in application 222, handled via a graphic user interface (GUI) 225. Similarly, client device 110 may provide a dataset 227 to server 130, wherein dataset 227 may include a search query, or a media file for uploading to database 252.

Server 130 includes a memory 220-2, a processor 212-2, a communications module 218-2, and an application programming interface (API) layer 215. Hereinafter, processors 212-1 and 212-2, and memories 220-1 and 220-2 will be collectively referred to, respectively, as “processors 212” and “memories 220.” Processors 212 are configured to execute instructions stored in memories 220. In some embodiments, memory 220-2 includes a content marketplace engine 232 and a creative matching engine 234. Content marketplace engine 232 may share or provide features and resources to application 222, including multiple tools associated with a creative project (e.g., a graphic design), via API layer 215. The user may access content marketplace engine 232 and creative matching engine 234 through application 222 or a web browser installed in a memory 220-1 of client device 110. Accordingly, application 222 may be installed by server 130 and perform scripts and other routines provided by server 130 through any one of multiple tools. Execution of application 222 may be controlled by processor 212-1.

In that regard, content marketplace engine 232 may include a search tool 240 and a license tool 241. The user employs search tool 240 to search for content (e.g., image files, video files, and/or audio files) for a graphic design being created in client device 110, and license tool 241 to license a selected content or media file from its creator (e.g., the contributor). Creative matching engine 234 may include a classification tool 242, an embedding tool 244, a ranking tool 246, a neural network tool 248, and a statistics tool 249. Classification tool 242 may include classifiers to find captions or textual descriptions and keywords for creatives (e.g., users and contributors) based on salient features in the creative description and attributes, and their history of licensing (e.g., downloading by a user, or a licensed content uploaded by a contributor) or uploading content (e.g., images, videos, audio files, and the like, uploaded by a contributor). Embedding tool 244 may assign a numeric value to the salient features, and thus locate the creative (user and/or contributor) in a multi-dimensional space where the dimensions are defined by the classifiers. In some embodiments, embedding tool 244 may be a dense vector embedding tool that computes dense vectors for the creatives. Dense vectors are a geometrical representation of a creative in a multidimensional space wherein each dimension indicates a semantic classifier or attribute of the creative (user or contributor). Accordingly, users and contributors to the content marketplace are represented as vectors in the same multidimensional space, such that a metric-defined distance between any two vectors (e.g., a cosine distance) is a measure of a similarity, compatibility, or synergy, between the user-contributor pair represented by the two vectors. Ranking tool 246 may assign a score to a creative pair (user-contributor) based on the metric-defined distance, and other considerations such as a history of previous pairings between the two creatives. The score may be associated to a volume in the multidimensional space defined by the embedded vectors associated with three or more creatives; for example, when embedding tool 244 defines a volume in the multi-dimensional space associated with multiple contributors centered around a user. Accordingly, ranking tool 246 may assign a score to each contributor based on the distance to the user vector. In general, the scores assigned by ranking tool 246 can be positive or negative and have any value. A lower score (positive or negative) indicates less compatibility or “synergy” than a higher score (positive or negative) between the associated pair. Accordingly, ranking tool 246 presents to the user a selected portion from the top of a list of contributors ranked by the user-creative score (e.g., the first five, the first ten, and the like).

Once ranking tool 246 determines a list of contributors to recommend to a user, it may be desirable to show selected content from the contributor galleries to the user. In some embodiments, ranking tool 246 selects content based on the application that the user is running. In some embodiments, the content for display to the user is chosen simply as the most popular content in the contributor's gallery, recently licensed content from the contributor, fresh content, conduct a search for a subject or topic, and the like. In some embodiments, ranking tool 246 identifies a popularity signal in the content itself, to choose content from the contributor galleries.

In some embodiments, ranking tool 246 provides personalized recommendation to users having more than a pre-selected threshold number of licenses per year. The pre-selected threshold can be greater than 50 but can also be changed accordingly. In some embodiments, ranking tool 246 targets only a subset of active users. In some embodiments, ranking tool 246 targets all users and treats less-active users with a simple logic (e.g., popular contributors are paired with inactive or less-active users). In some embodiments, ranking tool 246 recommends contributors based on a user's geo-features (e.g., attributes that are relevant in the country of the user).

Because users and contributors are creatives with similar attributes for creative matching engine 234, ranking tool 246 may provide contributor to contributor recommendations, based on contributors that got licenses from similar users. An application example for these could be a “More from similar artists” module in a graphic design application used by a contributor to generate content. In some embodiments, ranking tool 246 only recommends the top-k contributors in a ranking list. More generally, ranking tool 246 can score any user-contributor pair.

Classification tool 242, embedding tool 244, and ranking tool 246 use a neural network tool 248 to provide accurate and likable contributor recommendations to users. In some embodiments, neural network tool 248 may include a self-supervised or unsupervised network, where there are no style labels or creative captions to direct the algorithm to select a given pairing preference (e.g., niche or editorial creatives). In some embodiments, neural network tool 248 may be part of one or more machine learning models stored in a database 252. Database 252 includes training archives and other data files that may be used by creative matching engine 234 in the training of a machine learning model, according to user inputs through application 222. Moreover, in some embodiments, at least one or more training archives or machine learning models may be stored in either one of memories 220, and the user may have access to them through application 222. Neural network tool 248 may include algorithms trained for the specific purposes of the engines and tools included therein. The algorithms may include machine learning or artificial intelligence algorithms making use of any linear or non-linear algorithm, such as a neural network algorithm, or multivariate regression algorithm. In some embodiments, the machine learning model may include a neural network (NN), a convolutional neural network (CNN), a generative adversarial neural network (GAN), a deep reinforcement learning (DRL) algorithm, a deep recurrent neural network (DRNN), a classic machine learning algorithm such as random forest, k-nearest neighbor (KNN) algorithm, k-means clustering algorithms, or any combination thereof. More generally, the machine learning model may include any machine learning model involving a training step and an optimization step. In some embodiments, database 252 may include a training archive to modify coefficients according to a desired outcome of the machine learning model. Accordingly, in some embodiments, creative matching engine 234 is configured to access database 252 to retrieve documents and archives as inputs for the machine learning model. In some embodiments, creative matching engine 234, the tools contained therein, and at least part of database 252 may be hosted in a different server that is accessible by server 130 or client device 110.

Statistics tool 249 aggregates historical creative matching information stored in database 252, and licensing or downloading data for content from different creatives in the marketplace, as disclosed herein. Statistics tool 249 generates statistical information to enable an assessment of goals for creative matching engine 234. For example, statistics tool 249 may indicate, from the top-10 contributor recommendations provided to the users, how many were new user-contributor pairings, how many were associated with creatives from different geographic regions, languages, and the like. In some embodiments, statistics tool 249 determines how many of the top 10contributor recommendations provided to users are contributors with less than a pre-selected number of licenses or downloads. Statistics tool 249 also provides an indication of how many of the top 10 contributor recommendations in a given period of time are repeated creative matchings (same user-same contributor, same user-different contributor, different user-same contributor, and different user-different contributor). Statistics tool 249 may use the top 10 recommendations, the top 5 recommendations, or any pre-selected number of top recommendations desired by the user. In some embodiments, results determined by statistics tool 249 may inform the training and generation of the creative matching model with neural network tool 248.

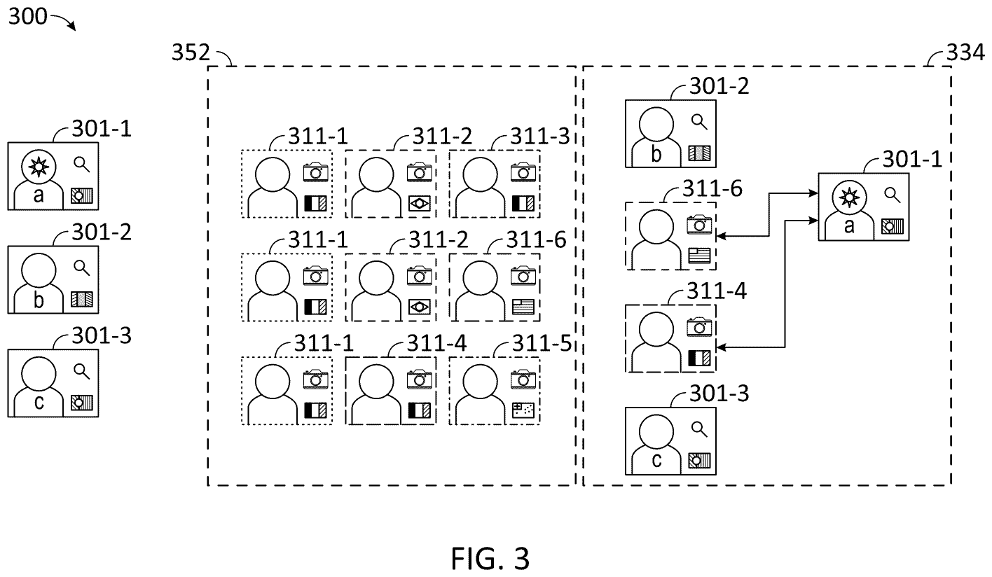

FIG. 3 illustrates a schematic diagram 300 of contributors 311-1, 311-2, 311-3, 311-4, 311-5 and 311-6 (hereinafter, collectively referred to as “contributors 311”) recommended to users 301-1, 301-2, and 301-3 (hereinafter, collectively referred to as “users 301”) based on nationality attributes, according to some embodiments. For example, users 301-1 and 301-3 may be Portuguese, and user 301-2 may be Italian. Contributors 311-1, 311-3, and 311-4 may be French, contributor 311-2 may be Brazilian, and contributor 311-6 may be from the US. Any other nationalities and regions in the world could be used for this exemplary illustration.

Accordingly, in a first round of recommendation (e.g., found in a recommendation history stored in a database 352), user 301-1 may receive content recommendations from contributors 311-1, 311-2, and 311-3. Likewise, user 301-2 may receive recommendations from contributors 311-1, 311-2, and 311-6. And user 301-3 may receive recommendations from contributors 311-1, 311-4, and 311-5.

A matching engine 334 may then provide recommendations from contributor 311-6 to user 301-1 given that users 301-1 and 301-2 shared two out of three contributor recommendations in the past (cf. contributors 311-1 and 311-2 in database 352). Moreover, matching engine 334 may provide recommendations from contributor 311-4 to user 301-1. To make this recommendation, matching engine 334 may weight in the fact that contributor 311-4 was recommended to user 301-3, who shares the same nationality as user 301-1. And the fact that contributor 311-4 shares the nationality with contributor 311-3, which was recommended to user 301-1 in the past (cf. database 352).

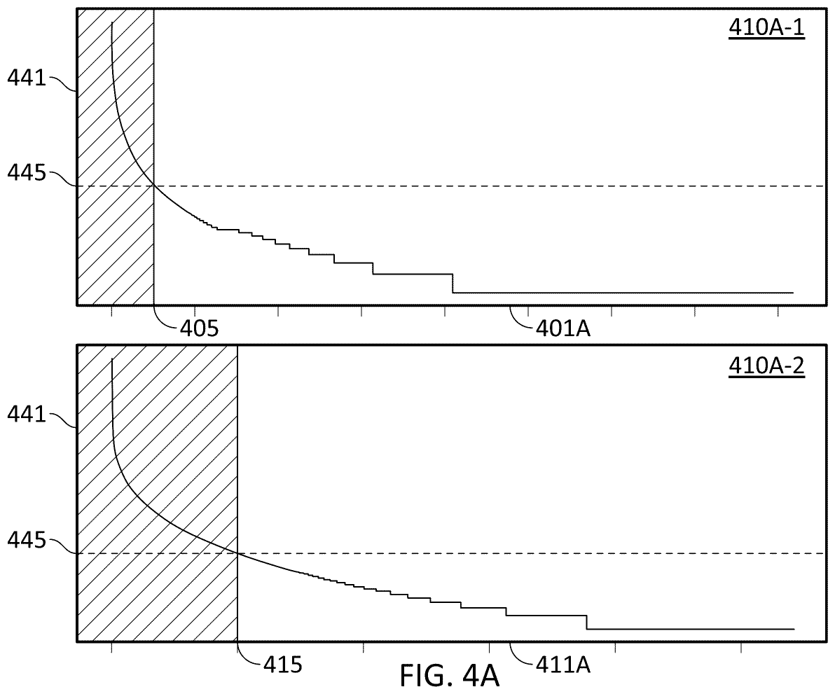

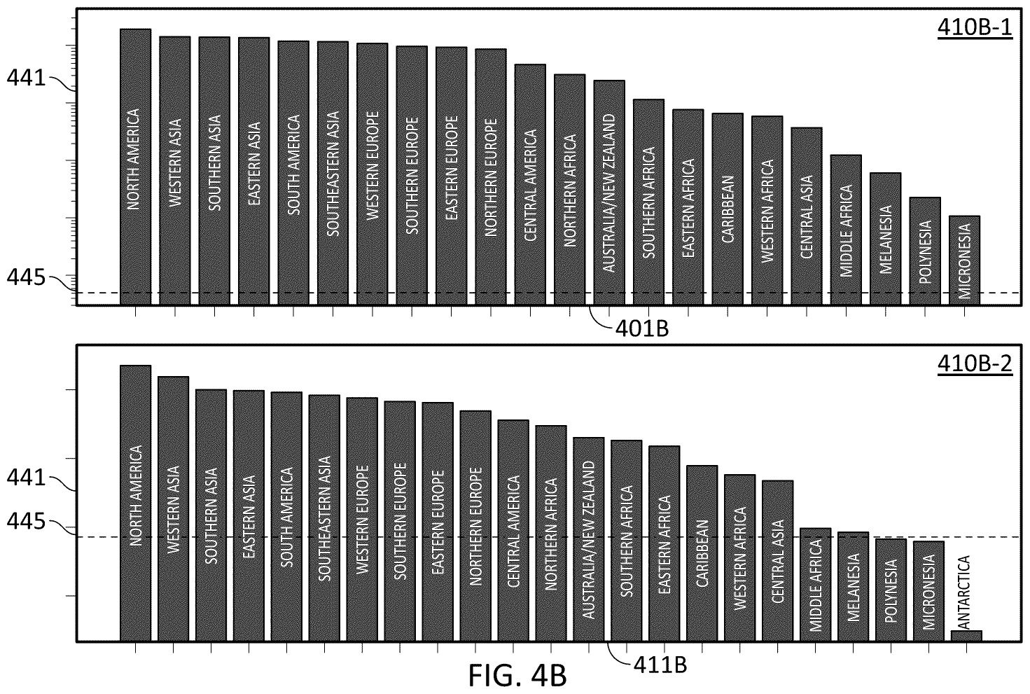

FIGS. 4A-4B illustrate charts 410A-1, 410A-2, 410B-1, and 410B-2 (hereinafter, collectively referred to as “charts 410”). Charts 410 include statistical information indicative of a license activity 441 amongst a population of users (401A and 401B, hereinafter, collectively referred to as “users 401”) and contributors (411A and 411B, hereinafter, collectively referred to as “contributors 411”) selected for training a model for user-contributor ranking and matching, according to some embodiments.

Charts 410A-1 and 410A-2 (hereinafter, collectively referred to as “creative license charts 410A”) indicate a selection 405 of users 401 and a selection 415 of contributors 411 that have licensed a threshold number of licenses 445, for training a model for user-contributor pair matching, as disclosed herein. The threshold number of licenses 445 may be any pre-selected number (e.g., less than 50, 50, 100, or more, per year). In some embodiments, the threshold number of licenses 445 may be different for selecting the universe of users 401 than for selecting the universe of contributors 411.

The threshold of >50 licenses per year is arbitrary is selected to have sufficient training data but also to select trustworthy contributors. Increasing the pre-selected threshold shifts recommendations to more solid/less niche contributors. A moderate increase in the threshold results in more engagement, but less contributor variety in the recommendations.

Charts 410B-1 and 410B-2 (hereinafter, collectively referred to as “origin license charts 410B”) indicate the origin of users (401B) and of contributors (411B). Origin license charts 410B are bar charts ordered according to license numbers 441 in each of the selected world regions. Note that a matching engine as disclosed herein may combine a user 401B and a contributor 411B from different regions of the world. In fact, in some embodiments, such mixed combinations may be promoted by a matching engine as disclosed herein, to promote diversity in the content download from users.

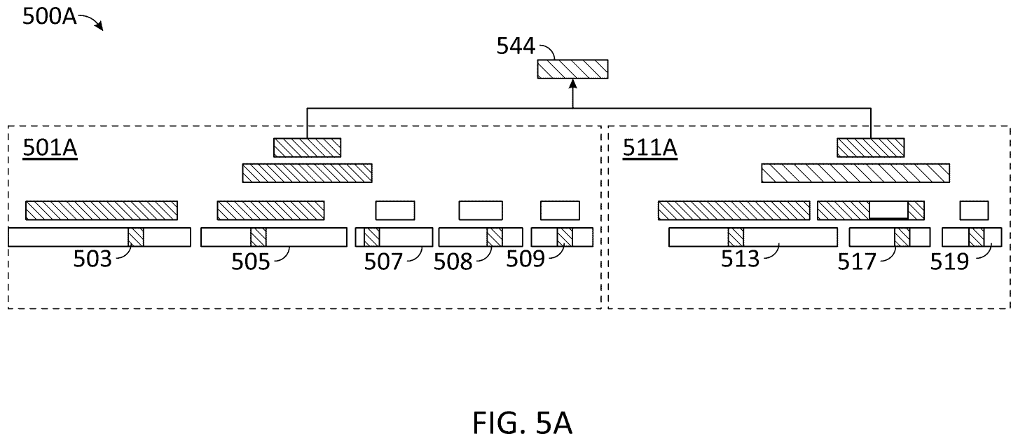

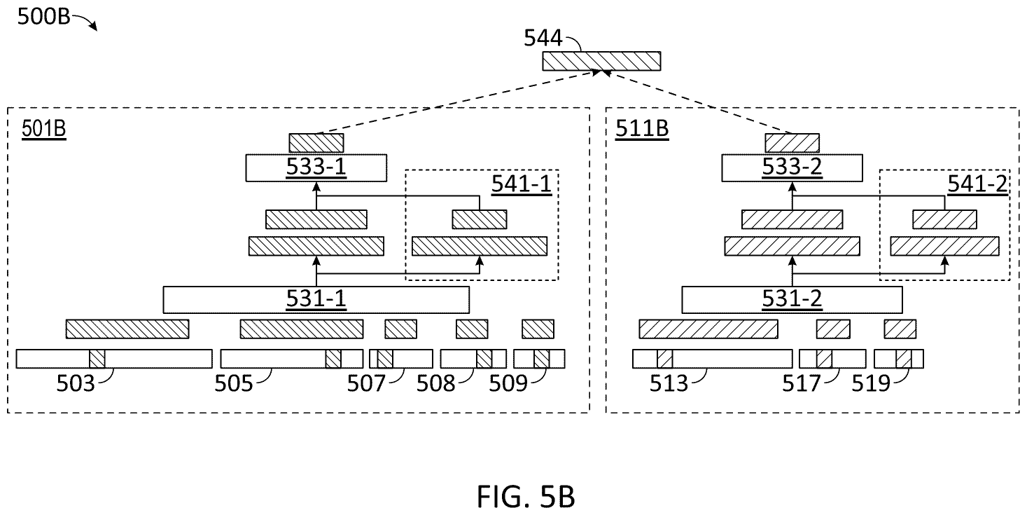

FIGS. 5A-5B illustrate neural network architectures 500A and 500B (hereinafter, collectively referred to as “neural networks 500”) for generating a model for user-contributor ranking and matching, according to some embodiments. Neural networks 500 may be generated by a neural network tool in a creative matching engine as disclosed herein (cf. neural network tool 248 in creative matching engine 234). To achieve this, the neural network tool may also use a classification tool and an embedding tool, as disclosed herein (e.g., classification tool 242 and embedding tool 244).

Neural networks 500 may include a “twin tower” structure with two parallel (e.g., uncorrelated) neural networks: user networks 501A and 501B (hereinafter, collectively referred to as “networks 501”) and contributor networks 511A and 511B (hereinafter, collectively referred to as “networks 511”). Networks 501 and 511 may include the same number of layers, but different inputs. For example, network 501 may include inputs for: a user ID input 503, an organization ID 505, a country of origin 507, a language 508, and a sub-continent 509. Network 511 may include inputs for: a contributor ID 513, a country of origin ID 517, and a sub-continent 519.

Networks 501 and 511 include convolution layers that result in a dense vector embedding 544 of users and contributors into the same, reduced dimensionality space. Accordingly, the input layer of networks 501 and 511 may include sparse vectors having “0” and “1” (with many more zeroes than ones), and a very large dimensionality (e.g., hundreds of thousands, or even millions). The dimensionality of dense vector embedding 544 may be much lower (e.g., tens of thousands, or thereabouts), with entries having any value between and including “0” and “1.”

Neural network 500B may be similar to neural network 500A, with the addition of concatenation layers 531-1, 531-2, 533-1, and 533-2 (hereinafter, collectively referred to as “concatenation layers 531 and 533,” respectively). In addition to concatenation layers 531 and 533, neural network 500B may include a deep cross-networks (DCN) 541-1 and 541-2 on each of the twin towers (user/contributor, respectively, and hereinafter, collectively referred to as “DCNs 541”). Concatenation layers 531 and 533 put together long vectors formed with the inputs, and also DCNs 541, prior to forming dense embedding 544. DCNs 541 cross-correlate a juxtaposition of different vector components to compare with the normal sequence layer in concatenation layers 533.

Once dense vector embedding 544 places user vectors and contributor vectors in the same dimensionality space, a metric distance between these vectors can be measures, e.g., via vector cosine calculation between components. The distance between user-contributor vectors can be used to rank the contributors around a user based on the distance to the user vector.

Neural networks 500 compute scores of user-contributor pairs based on their vector embeddings 544. During training, neural networks 500 learn from each user and contributor historical behavior, and leverage additional features (country 507 and 517 and sub-continent 509 and 519) that allow to leverage geographic preferences for the scoring. Neural networks 500 not only learn higher scores for user-contributor pairs that have interacted before, but discover new synergies based on creatives having similar behaviors. When user_a has interacted with contributors k,f,g and user_b has interacted with contributors f,g,z, neural networks 500 learn a high score for user_b and contributor_k, and for user_a and contributor z.

Neural networks 500 are optimized using batch optimization, where a batch is constructed of positive user-contributor pairs, and the counterparts (random pairs) are considered negatives. As a result of the batch optimization, popular contributors that get purchases from many different users are penalized because these pairs are more frequently included within the negative pairs. As a result, neural networks 500 boost recommendations of less popular, or new contributors that naturally get licenses from fewer users.

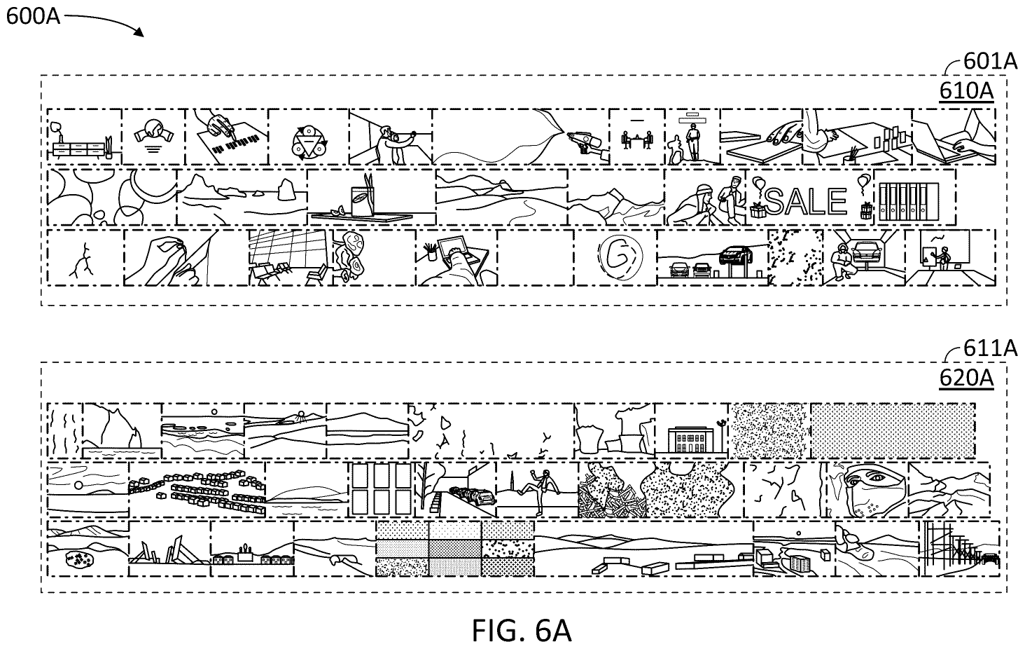

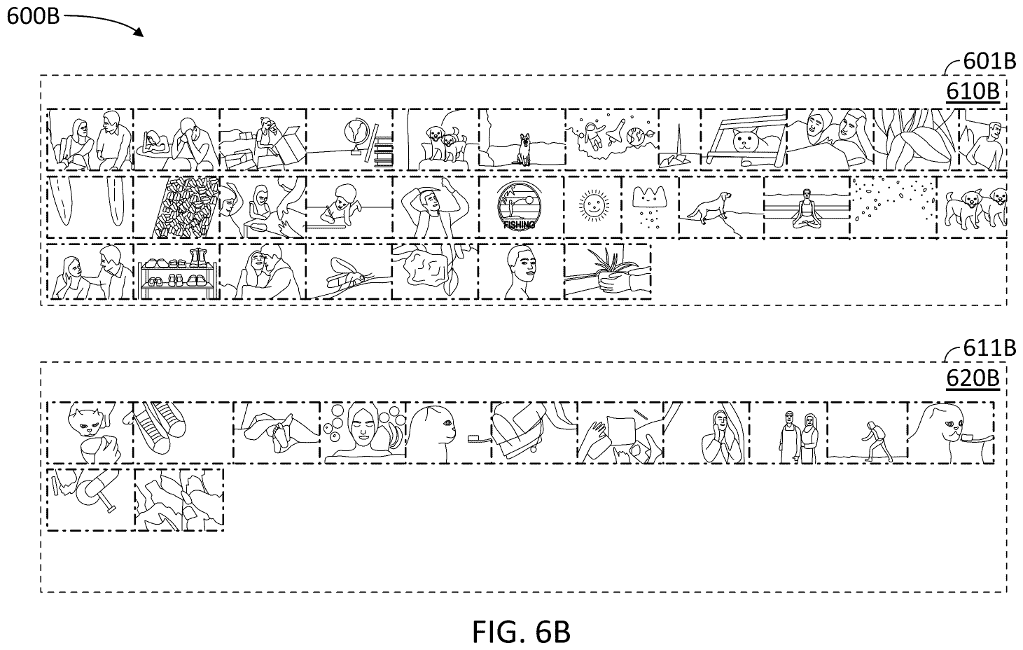

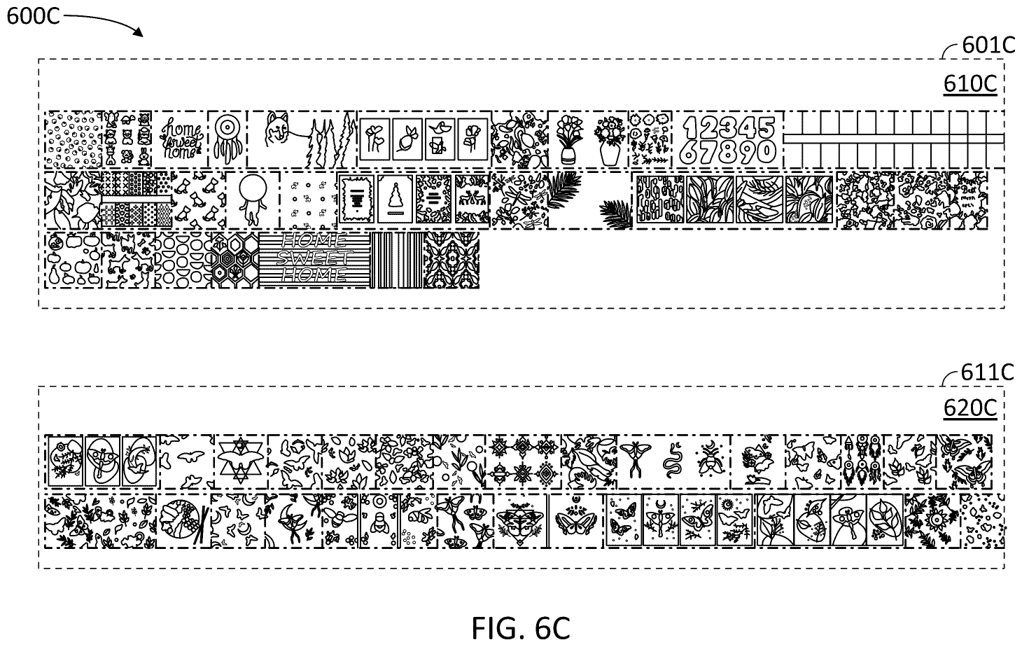

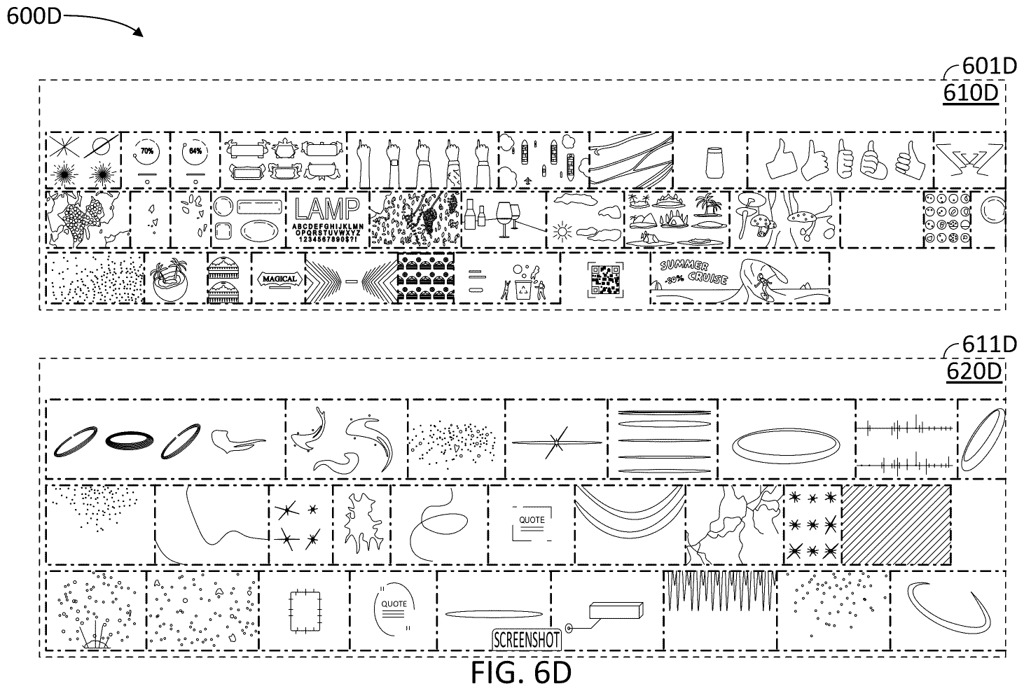

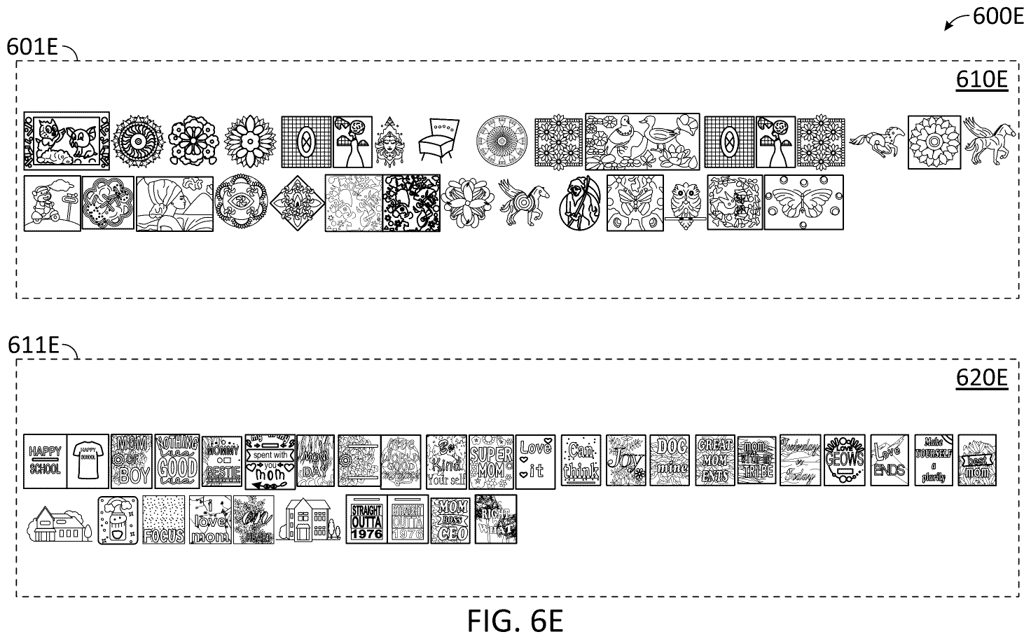

FIGS. 6A-6E illustrate panels 600A, 600B, 600C, 600D, and 600E (hereinafter, collectively referred to as “panels 600”), according to some embodiments. Panels 600 include user-leased images 610A, 610B, 610C, 610D, and 610E (hereinafter, collectively referred to as “user-leased images 610”), and contributor-released images 620A, 620B, 620C, 620D, and 620E (hereinafter, collectively referred to as “contributor-released images 620”). A creative matching engine recommends each of contributors 611A, 611B, 611C, 611D, and 611E (hereinafter, collectively referred to as “contributors 611”) to each of users 601A, 601B, 601C, 601D, and 601E (hereinafter, collectively referred to as “users 601”). In some embodiments, the contributor recommendations provided by the creative matching engine may be less based on style features in user-leased images 610 or contributor-released images 620, than on licensing patterns and other creative attributes (e.g., user-contributor geographic residence and prior licensing history), as disclosed herein.

In panel 600A, user 601A has subscribed 169 licenses, and contributor 611A has released 309 licenses. User 601A and contributor 611A have no prior licenses, and the pair score is low (0.950). Yet, the system puts contributor 611A at the top-ranking recommendation for user 601A.

In panel 600B, user 601B has subscribed 2351 licenses, and contributor 611B has released 33 licenses. User 601B and contributor 611B have no prior licenses, and the score is relatively low (2.745), and yet, the recommendation engine puts contributor 611B as a top-ranking recommendation for user 601B. The model also recommended low-tier contributors, and this is a top-1 recommendation for a highly active user.

In panel 600C, user 601C has subscribed 602 licenses, and contributor 611C has released 107 licenses. User 601C and contributor 611C have one prior license, and the score is relatively low (3.751). To refine recommendations, the matching engine also recommends contributors that a user has interacted with before, for a few times.

In panel 600D, user 601D has subscribed 193 licenses, linked to a contributor 611D that has released 683 licenses. User 601D and contributor 611D have no prior license, and the score is low (−0.078), yet the matching engine recommends contributor 611D in first rank, to user 601D. A low score usually means that the user has diverse preferences.

In panel 600E, user 601E has subscribed 298 licenses, and contributor 611E has released 189 licenses. User 601E and contributor 611E have no prior license, and the score is high (8.703), yet the matching engine ranked this contributor in place 9. A high score usually means that the user licenses very specific images and same for the contributors (niche users and contributors).

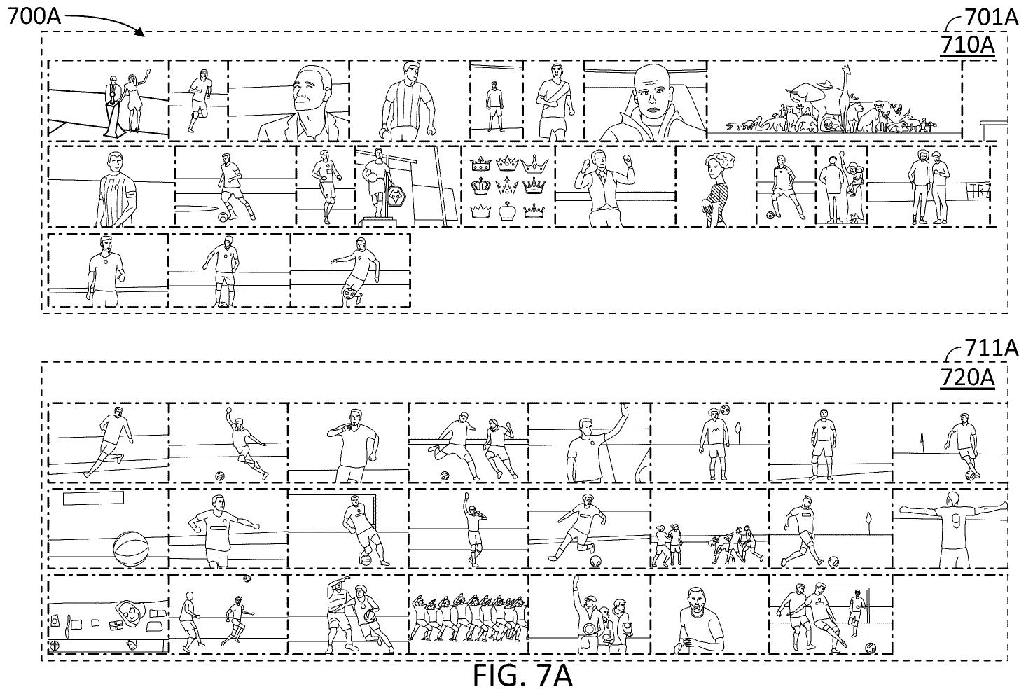

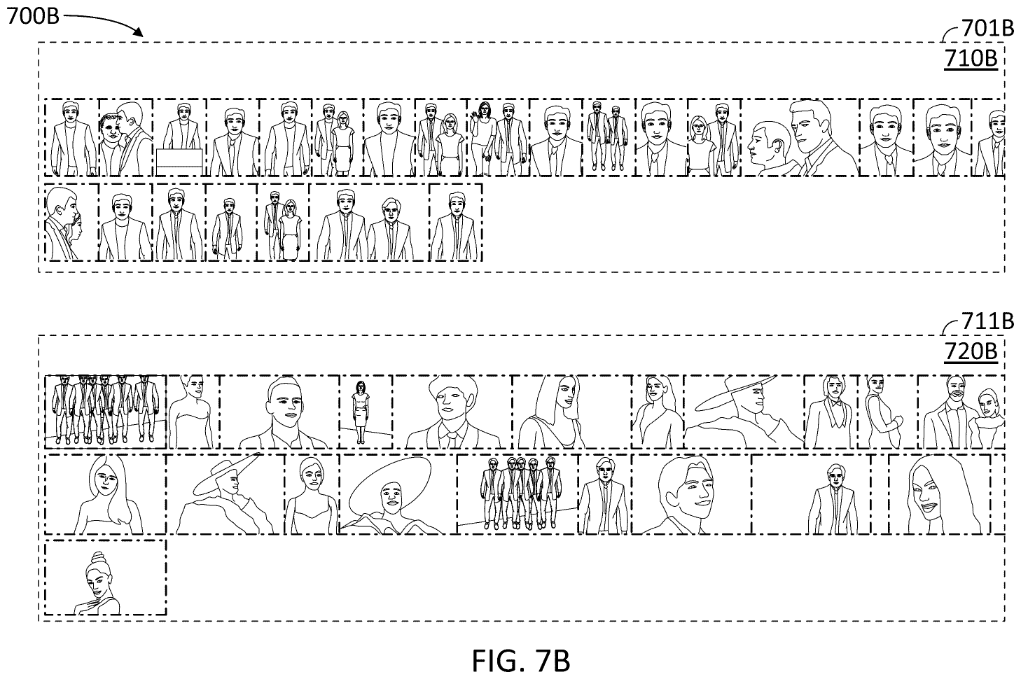

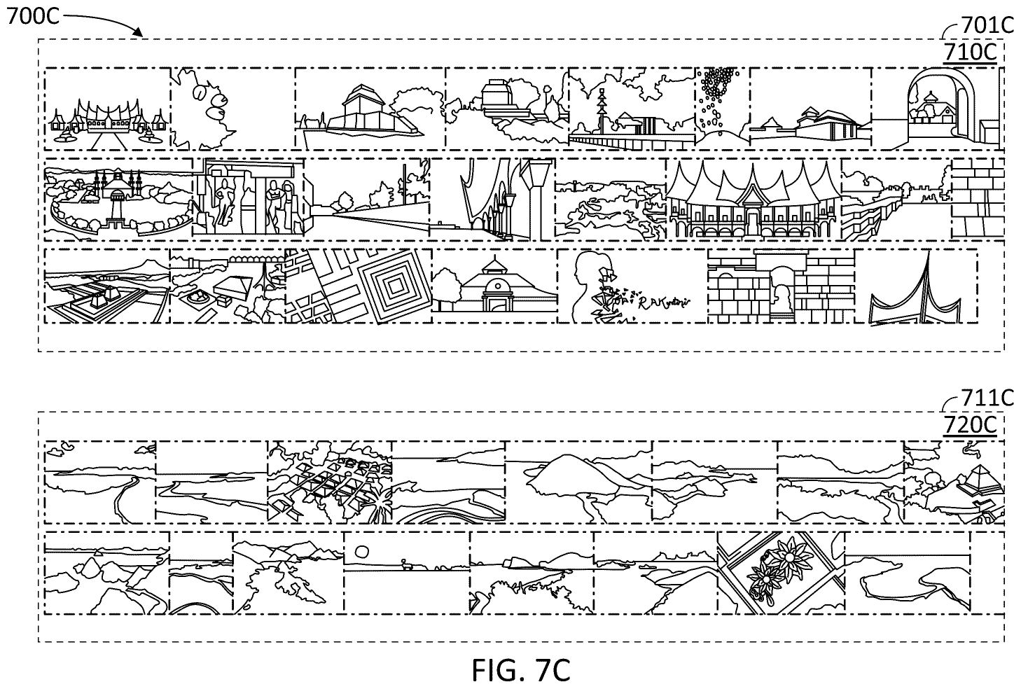

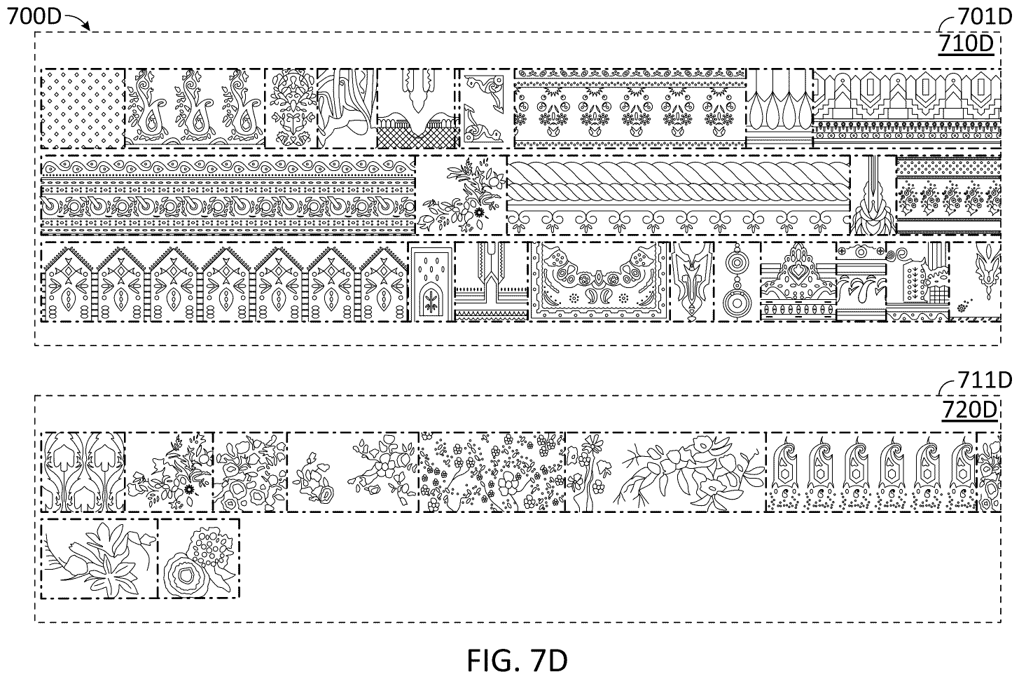

FIGS. 7A-7D illustrate panels 700A, 700B, 700C, and 700D (hereinafter, collectively referred to as “panels 700”), according to some embodiments. Panels 700 include user-leased images 710A, 710B, 710C, and 710D (hereinafter, collectively referred to as “user-leased images 710”), and contributor-released images 720A, 720B, 720C, and 720D (hereinafter, collectively referred to as “contributor-released images 720”). A creative matching engine recommends each of contributors 711A, 711B, 711C, and 711D (hereinafter, collectively referred to as “contributors 711”) to each of users 701A, 701B, 701C, and 701D (hereinafter, collectively referred to as “users 701”). Editorial creatives (e.g., people who work in specialized magazines or sports news reports) typically lead to high scores. To create diversity, it may be desirable to place these types of contributors 711 in a lower ranking, for users 701. In some embodiments, the matching engine may pair a niche user and a niche creative, even when the pair has a large score.

In panel 700A, user 701A has licensed 303 images and contributor 711A has released 229 images. User 701A and contributor 711A have no prior licenses, the pair score is high, 11.227, and yet the matching engine places contributor 711A in 10^{th} place of the list proposed to user 701A.

In panel 700B, user 701B has licensed 235 images and contributor 711B has released 79 images. User 701B and contributor 711B have no prior licenses, the pair score is high, 11.414, and yet the matching engine places contributor 711B in 10^{th} place of the list proposed to user 701B.

In panel 700C, user 701C has licensed 188 images and contributor 711C has released 51 images. User 701C and contributor 711C have no prior licenses, the pair score is high, 8.033, and yet the matching engine places contributor 711C in 9^{th} place of the list proposed to user 701C.

In panel 700D, user 701D has licensed 448 images and contributor 711C has released 23 images. User 701D and contributor 711D have no prior licenses, the pair score is high, 11.280, and yet the matching engine places contributor 711D in 3^{rd} place of the list proposed to user 701D.

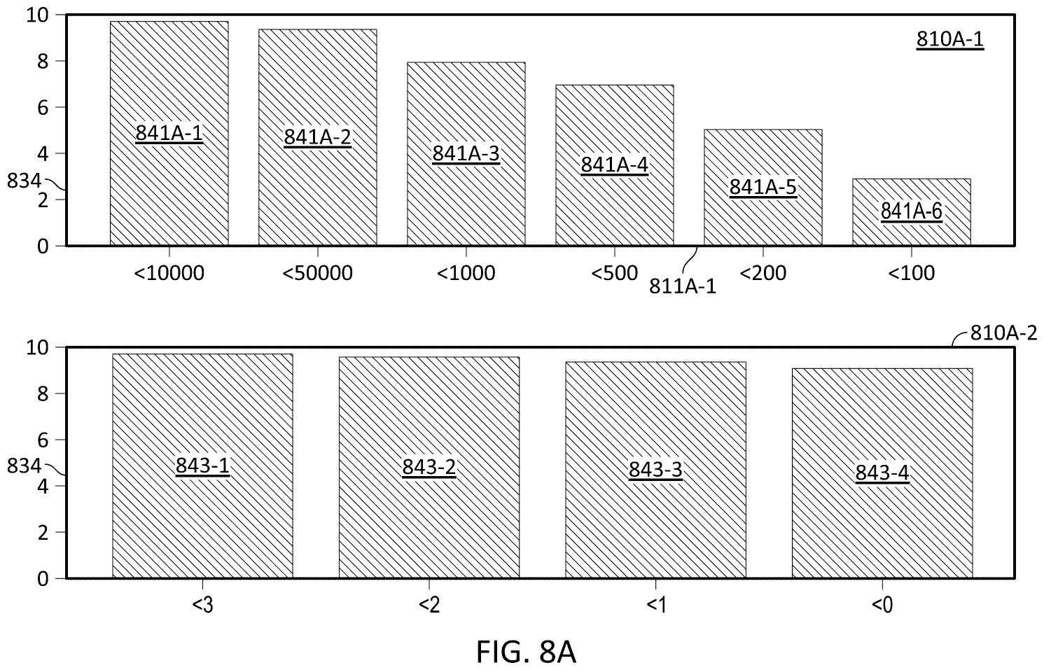

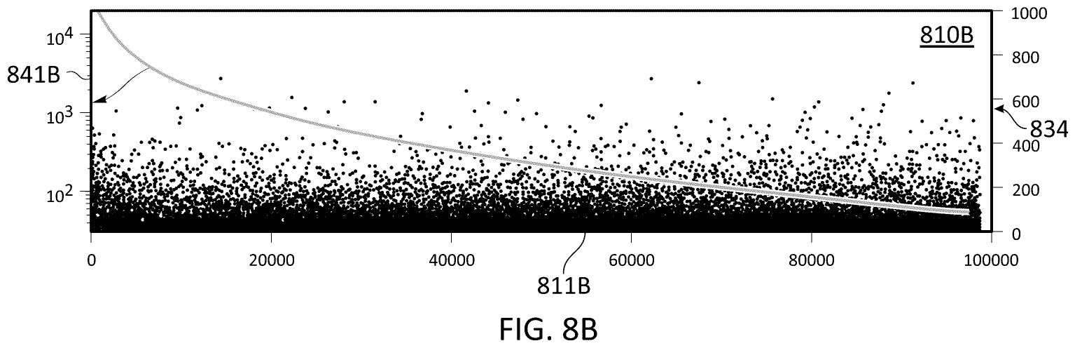

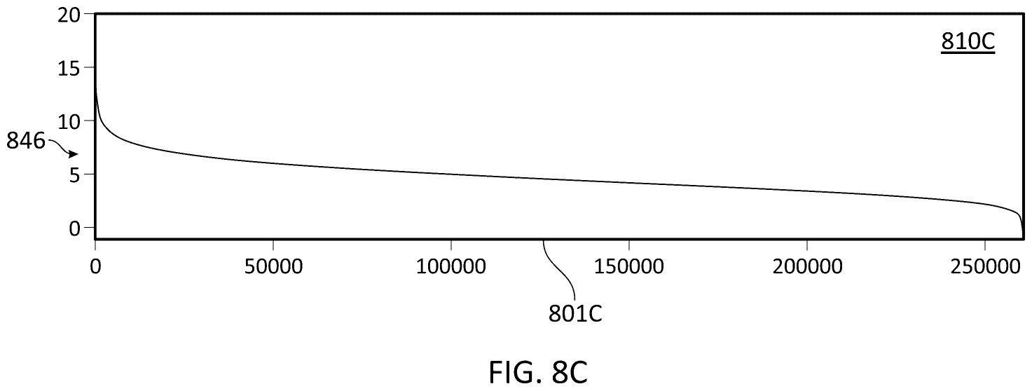

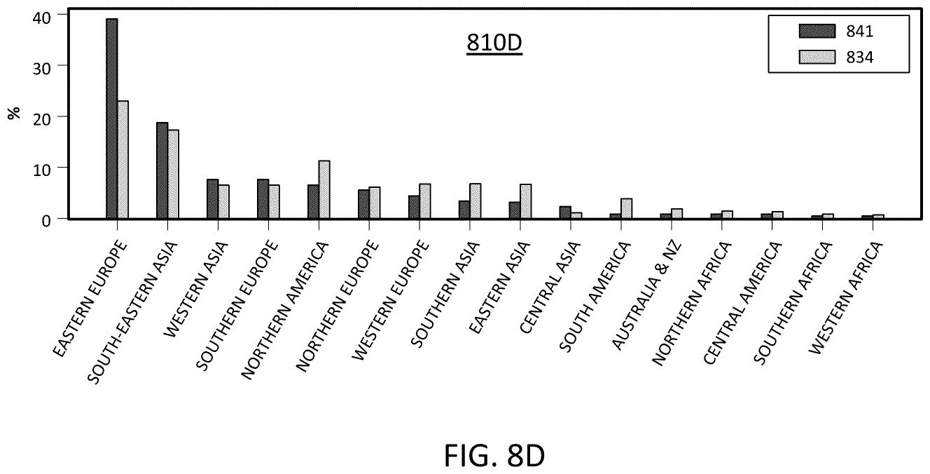

FIGS. 8A-8D illustrate charts 810A-1, 810A-2, 810B, 810C, and 810D (hereinafter, collectively referred to as “charts 810”) including statistical information indicative of the diversity in contributor recommendations to users based on a ranking and matching model, according to some embodiments.

Charts 810A-1 and 810A-2 (hereinafter, collectively referred to as “histograms 810A”) plot an average frequency 834 of appearing in the top ten recommendations for any user in the system, for two different types of contributors 811A-1 and 811A-2 (hereinafter, collectively referred to as “contributors 811”).

Contributors 811A-1 are separated by the number of licenses released by the contributor. Accordingly, bar 841A-1 includes the number of recommendations of the top ten issued by the matching engine for users, wherein the contributors had released up to ten-thousand (<10,000) licenses. Bar 841A-2 includes the number of recommendations of the top ten issued by the matching engine for users, wherein the contributors had released up to five-thousand (<5000) licenses. Bar 841A-3 includes the number of recommendations of the top ten issued by the matching engine for users, wherein the contributors had released up to one-thousand (<1000) licenses. Bar 841A-4 includes the number of recommendations of the top ten issued by the matching engine for users, wherein the contributors had released up to five-hundred (<500) licenses. Bar 841A-5 includes the number of recommendations of the top ten issued by the matching engine for users, wherein the contributors had released up to two-hundred (<200) licenses. Bar 841A-6 includes the number of recommendations of the top ten issued by the matching engine for users, wherein the contributors had released up to one-hundred (<100) licenses. Chart 810A-1 illustrates that, on average, 7/10 contributors recommended by a matching engine as disclosed herein have less than 500 prior leased images. In fact, about 3/10 recommended contributors have less than 100 prior leased images. Accordingly, chart 810A-1 proves that the matching engine allows for contributors with fewer leased images to appear in the recommendations list. This mitigates the “cold start” effect, where a contributor that recently joined the network tends to get little promotion under previous configurations simply for the lack of historical data in the network. A matching engine as disclosed herein effectively promotes low-tier contributors (e.g., niche contributors to niche users), which often get overlooked in standard matching techniques.

Contributors 811A-2 are separated by the number of licenses agreed with a given user in the previous year, which still appear within the top 10 recommendations for the given user as illustrated in bars 843-1, 843-2, 843-3, and 843-4 (hereinafter, collectively referred to as “bars 843”). On average, chart 810A-2 illustrates that 9/10 top recommendations were made for contributors that had no prior history of licensing images with the respective users. This indicates the low bias of a matching engine as disclosed herein against new contributors and new contributor-user pairs.

Chart 810B plots the number of licenses 841B (left-side ordinates) obtained and the number of occurrences (right-side ordinates) within a top-10 recommendation for each of the contributors in the universe selected (e.g., those contributors that got more than 50 licenses), for a matching engine as disclosed herein. Chart 810B illustrates that the frequency that a contributor appears in a top-10 recommendation is uncorrelated with the number of licenses obtained by the contributor. When the points in the distribution for number of occurrences is aggregated along the contributors, the result is that 84% of the total number of contributors (i.e., 84 thousand) appear at least once in the top-10 recommendations issued by the matching engine.

Chart 810C illustrates the users 801C in the selected universe of users (X-axis, abscissae), sorted according to the score value of the top recommendation 846 (Y-axis, ordinates). Accordingly, chart 810C indicates that for most users the top recommendation had a score between about 3 and 13, which is far from the highest score available in the sampled universe (>20). The uniformity of the distribution in chart 810C around mid-low score values indicates the lack of bias of the matching engine towards higher scores. Top scores 846 are interpretable and insightful to foretell the nature of the recommendations and design applications: Users 801C with high recommendation scores are niche users with very specific image interests (e.g., towards the left of chart 810C), and so are their recommended contributors. Meanwhile, the interests of users 801C with lower scores are more diverse (e.g., towards the right of chart 810C), which results in more heterogeneous recommendations. The lower score of more heterogeneous recommendations is associated with a lower certitude that the recommendation will be heeded by a user 801C. Despite the diversity of our users and contributors, the matching engine manages to provide relevant recommendations for them all, achieving at the same time a great balance within contributors in recommendations, and therefore contributing to spread the licenses across them.

Recommendation scores vary within users. In general, the higher the score, the more niche the users and the recommended contributor, with a higher engagement (e.g., likelihood of a license). In some embodiments (e.g., user receives emails with recommendations), the matching engine targets a subset of user-contributor pairs having the highest scores. In some embodiments, a creative matching model may be trained by comparing the same contributor recommendations for different users.

Chart 810D is a bar chart with percentages of licensed obtained 841 and occurrences in top-10 user recommendations wherein at least one of the user or contributor belong in a selected region of the world (Eastern Europe, South-eastern Asia, Western Asia, Southern Europe, North America, Northern Europe, Western Europe, Southern Asia, Eastern Asia, Central Asia, South America, Australia and NZ, North Africa, Central America, Southern Africa, and Western Africa). It can be seen that for areas of the world with little incidence in the number of licenses, a greater proportion of recommendations are issued by a matching engine as disclosed herein. This indicates that the matching engine as disclosed fosters and promotes a desired diversity in the offerings and recommendations to creatives in a content marketplace. For example, in North America, which is the origin of most users in an online content marketplace, almost double the percentage of recommendations are from that region of the world, to reflect this fact.

Charts 810 may help devise strategies to increase contributor quality in an online content marketplace. For example, recommending contributors having no less than a pre-selected threshold of licenses in the previous year, or having a pre-selected gallery size, or from which the user has already licensed images before. In some embodiments, the top-k recommendations of the matching engine may be randomized (rather than sorted by rank) each time the list is updated, where k can be any integer: 5, 10, or even more.

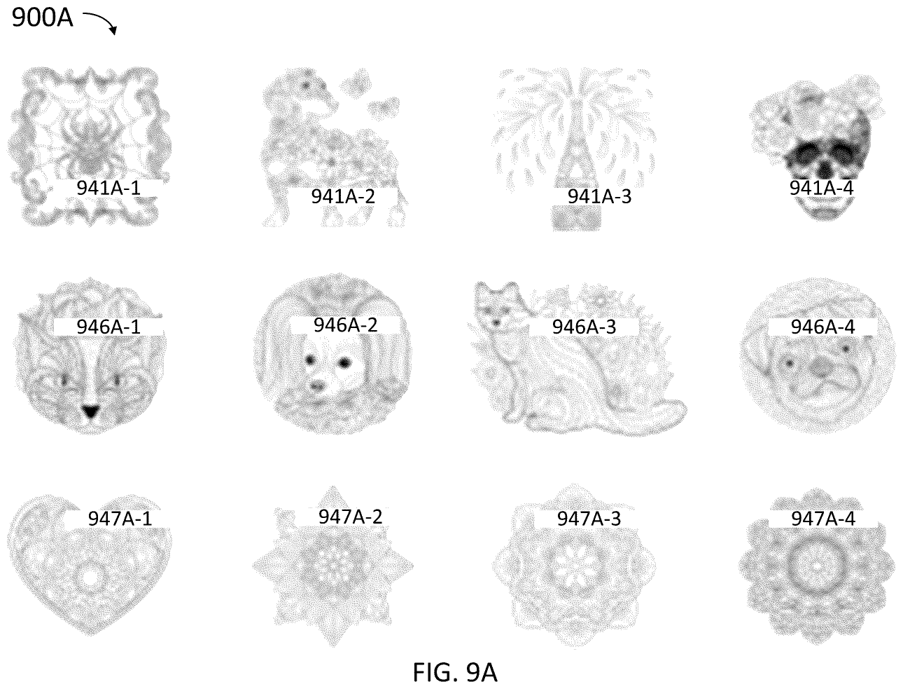

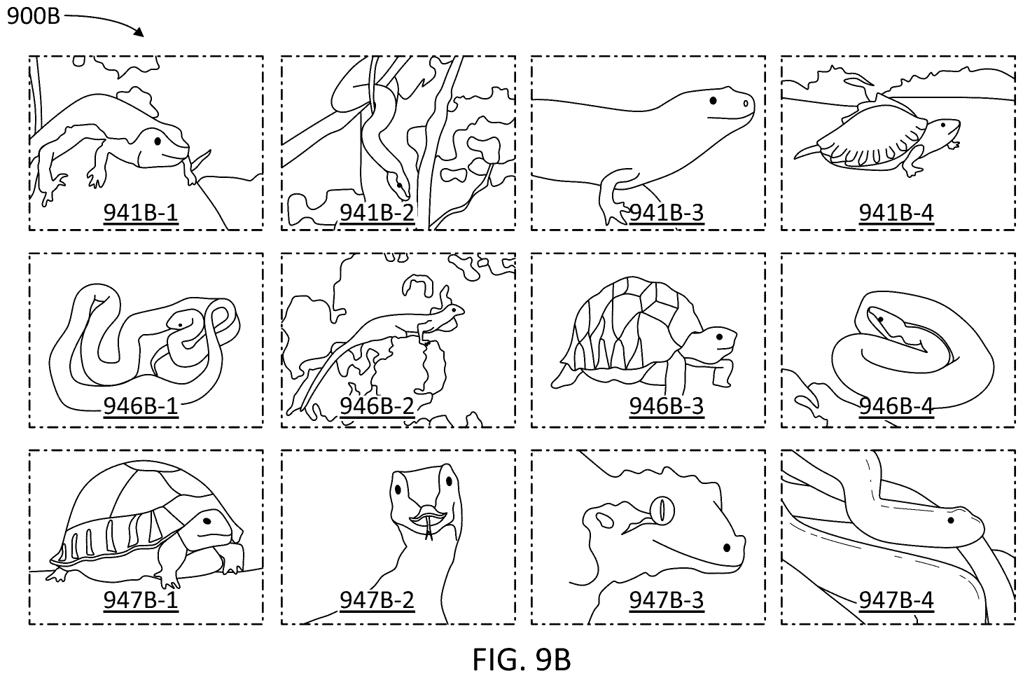

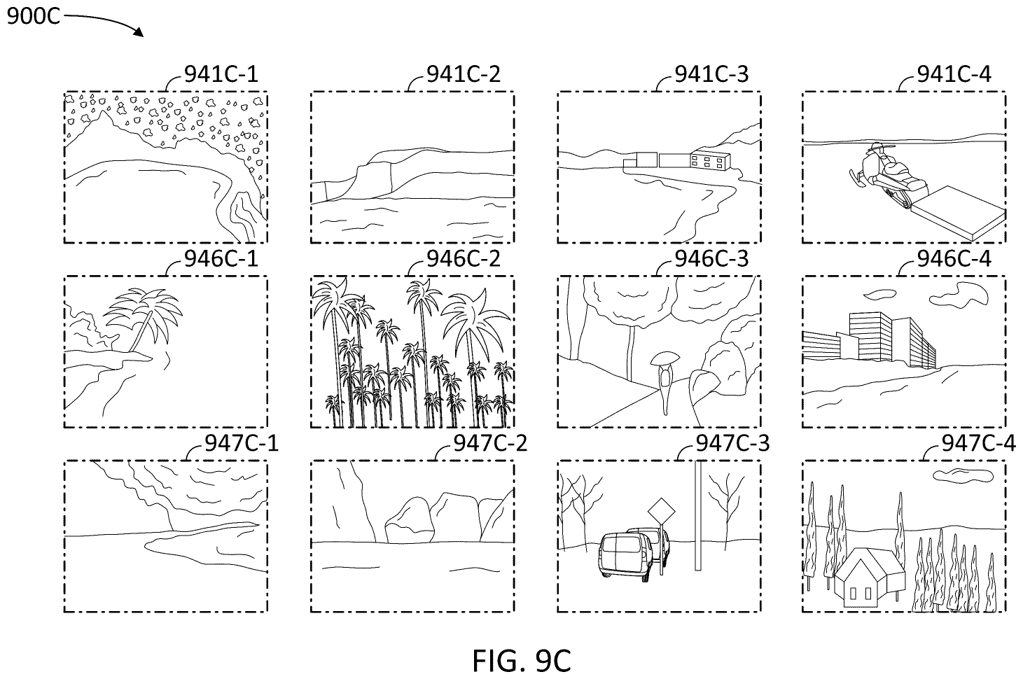

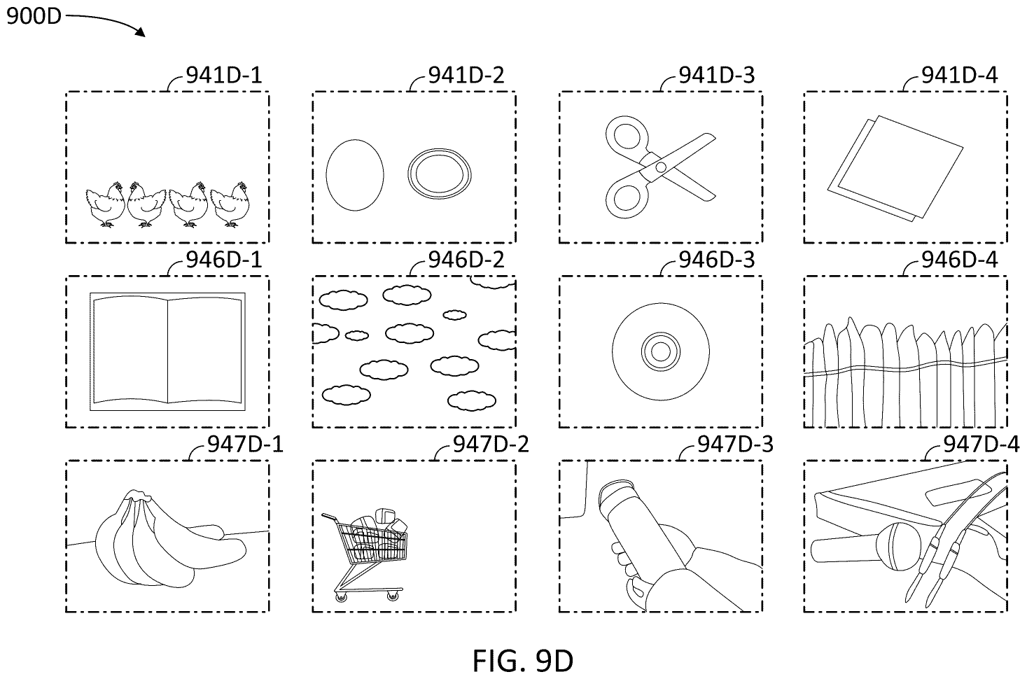

FIGS. 9A-9D illustrate user lease history and top-ranking contributor recommendations provided by a ranking and matching model, according to some embodiments. Panels 900A, 900B, 900C, and 900D (hereinafter, collectively referred to as “panels 900”) include leased images and the top first and second image recommendations from contributors provided by a creative matching engine as disclosed herein. None of the leased images were selected from the top first or two recommendations, indicative of the large contributor pool and the boost of the matching engine to less popular or lesser known contributors.

Panel 900A includes leased images 941A-1, 941A-2, 941A-3, and 941A-4 (hereinafter, collectively referred to as “leased images 941A”). The user has very specific style interests (e.g., black and white drawings of fantastic images). The top first recommended images 946A-1, 946A-2, 946A-3, and 946A-4 (hereinafter, collectively referred to as “recommended images 946A”) have a score of about 15.4. The top second recommended images 947A-1, 947A-2, 947A-3, and 947A-4 (hereinafter, collectively referred to as “recommended images 947A”) have a score of about 15.2. Accordingly, niche image interest leads to niche contributor recommendations.

Panel 900B includes leased images 941B-1, 941B-2, 941B-3, and 941B-4 (hereinafter, collectively referred to as “leased images 941B”). The user has very specific style interests (e.g., reptilian images). The top first recommended images 946B-1, 946B-2, 946B-3, and 946B-4 (hereinafter, collectively referred to as “recommended images 946B”) have a score of about 8.4. The top second recommended images 947B-1, 947B-2, 947B-3, and 947B-4 (hereinafter, collectively referred to as “recommended images 947B”) have a score of about 7.8. What we see here is that niche user interests on a popular field (e.g., reptilian images) results in niche contributor recommendations but with a somewhat lower score than in panel 900A.

Panel 900C includes leased images 941C-1, 941C-2, 941C-3, and 941C-4 (hereinafter, collectively referred to as “leased images 941C”). The user has more broad and common interests (e.g., travel and vacation). The top first recommended images 946C-1, 946C-2, 946C-3, and 946C-4 (hereinafter, collectively referred to as “recommended images 946C”) have a score of about 5.2. The top second recommended images 947C-1, 947C-2, 947C-3, and 947C-4 (hereinafter, collectively referred to as “recommended images 947C”) have a score of about 5.1. Recommended images 946C and 947C are also coming from contributors with broad and common interests (lower scores).

Panel 900D includes leased images 941D-1, 941D-2, 941D-3, and 941D-4 (hereinafter, collectively referred to as “leased images 941D”). The user has very diverse interests (e.g., books, fruits, sky, scattered objects in sharp colors, and the like). The top first recommended images 946D-1, 946D-2, 946D-3, and 946D-4 (hereinafter, collectively referred to as “recommended images 946D”) have a score of about 0.57. The top second recommended images 947D-1, 947D-2, 947D-3, and 947D-4 (hereinafter, collectively referred to as “recommended images 947D”) have a score of about 0.56. Recommended images 946D and 947D are coming from a heterogeneous collection of contributors with varied galleries and a lower confidence score.

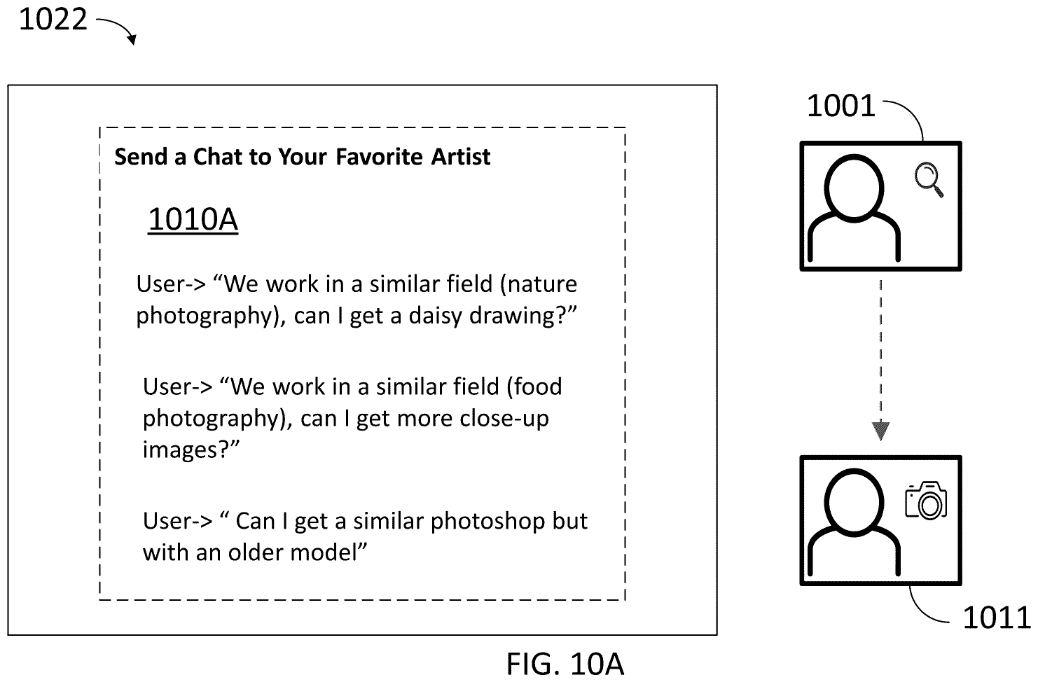

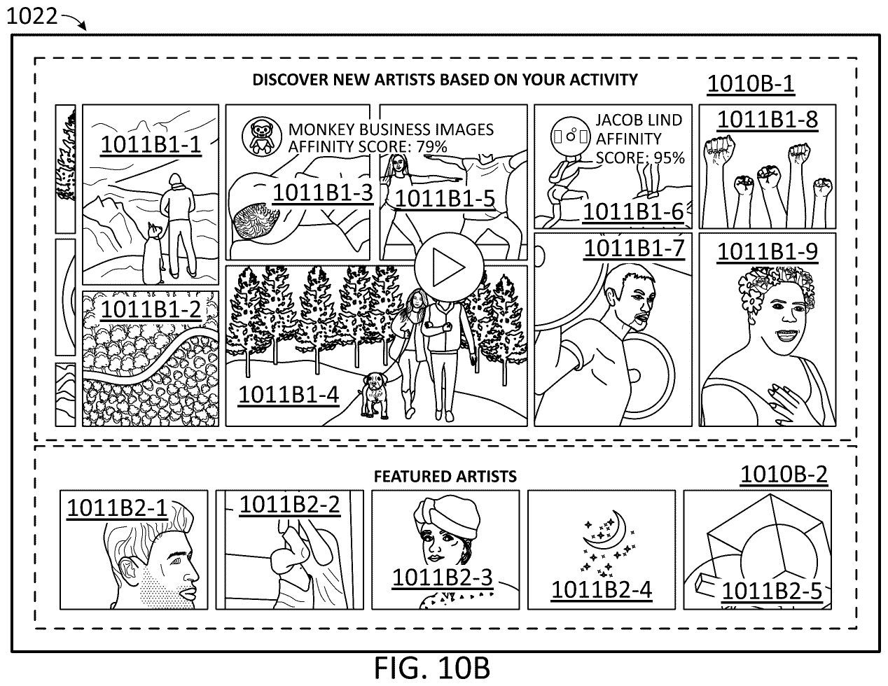

FIGS. 10A-10B illustrate different views of a graphic design application 1022 hosted by a creative machine engine that enables user-contributor interactions, according to some embodiments.

A field 1010A enables user 1001 to “send a chat to your favorite artist [contributor].” Field 1010A opens a message prompt for user 1001 to message contributor 1011 (“We work in a similar field [or have similar interests, nature photography, food photography], can I get a daisy drawing/more close-up images from you,” or “can I get a similar photoshop but with an older model”).

Graphic design application 1022 may also include a field 1010B-1 for users to “discover new artists based on your past activity.” Accordingly, field 1010B-1 includes different contributors 1011B1-1, 1011B1-2, 1011B1-3, 1011B1-4, 1011B1-5, 1011B1-6, 1011B1-7, 1011B1-8, and 1011B1-9 (hereinafter, collectively referred to as “new contributors 1011B1”) with thumbnails where user 1001 can scroll over and have a quick preview of the contributor's work. The creative matching engine populates field 1010B-1 with new contributors 1011B1 which, while not being the “most popular contributors,” are similar and likely to be licensed by user 1001. By selecting any of the contributors 1011, user 1001 may access a gallery with content from a new contributor 1011B1. User 1001 may also chat with new contributor 1011B1, and even request a specific content file. A field 1010B-2 may include featured artists (e.g., contributors 1011B2-1, 1011B2-2, 1011B2-3, 1011B2-4, and 1011B2-5, hereinafter, collectively referred to as “contributors 1011B2”) that the match engine may determine to be of interest to user 1001.

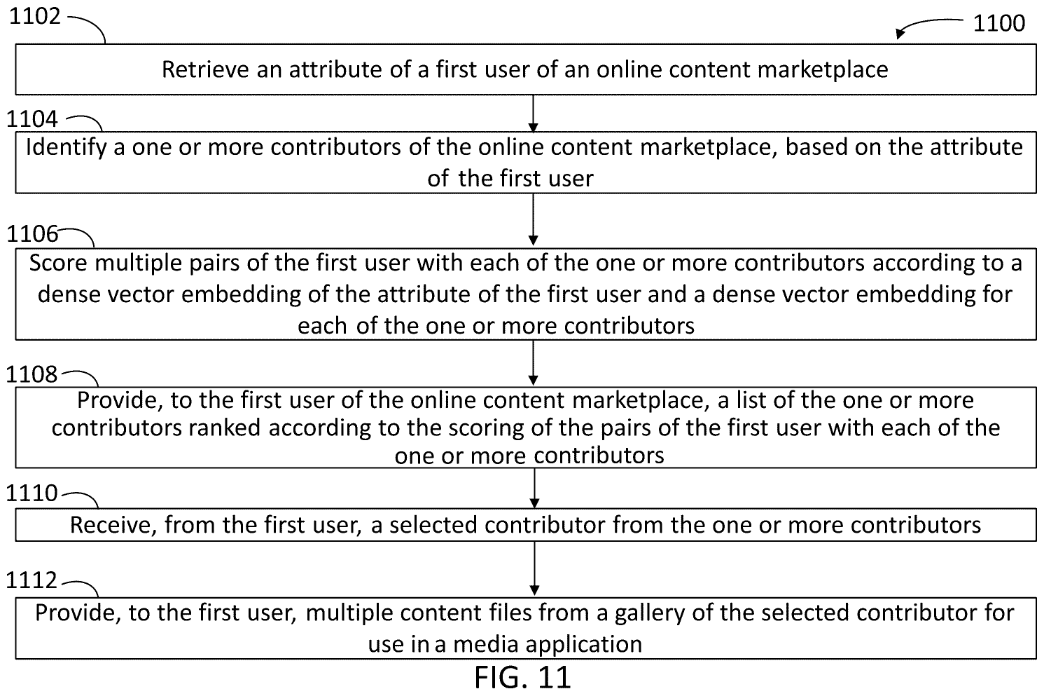

FIG. 11 is a flow chart illustrating steps in a method 1100 for matching creatives in a content marketplace, according to some embodiments. At least one or more of the steps in method 1100 may be performed by a computer system in a client device or a server, the client device and the server being communicatively coupled through a network via a communications module (e.g., client device 110, server 130, network 150, and communications modules 218). The computer system may include a memory storing instructions which, when executed by a processor, perform at least partially one or more of the steps in method 1100 (e.g., processors 212 and memories 220). In some embodiments, one or more steps in method 1100 is at least partially executed by a graphic design application installed in the client device and hosted by a content marketplace engine and a creative matching engine in the server (e.g., application 222, content marketplace engine 232, and creative matching engine 234). Further, in some embodiments, one or more of the steps in method 1100 may be performed by a search tool, a license tool, a classification tool, an embedding tool, a ranking tool, a neural network tool, and a statistics tool, in the content marketplace engine and the creative matching engine (e.g., search tool 240, license tool 241, classification tool 242, embedding tool 244, ranking tool 246, neural network tool 248, and statistics tool 249). Further, in some embodiments, data and information used in, or generated by, at least one of the steps in method 1100 (e.g., a user-contributor matching recommendation history, a content licensing history, a search history) may be stored in a database communicatively coupled to, and hosted by, the server (e.g., database 252). Methods consistent with the present disclosure may include at least one or more of the steps in method 1100 performed in a different order. For example, in some embodiments, steps in method 1100 may be performed simultaneously, quasi-simultaneously, or overlapping in time.

Step 1102 includes retrieving an attribute of a first user of an online content marketplace. In some embodiments, step 1102 further includes retrieving an attribute of a user of an online content marketplace.

Step 1104 includes identifying a one or more contributors of the online content marketplace, based on the attribute of the first user. In some embodiments, step 1104 further includes selecting a contributor from a same place of origin than the first user. In some embodiments, step 1104 further includes selecting a contributor from a ranked list of contributors provided to a second user from a same place of origin of the first user. In some embodiments, step 1104 further selects a first contributor from a same contributor place of origin as a second contributor in a ranked list provided to a second user from a same place of origin of the first user. In some embodiments, step 1104 further includes identifying a one or more contributors of the online content marketplace comprises selecting a contributor with whom the first user has a prior content license.

Step 1106 includes scoring multiple pairs of the first user with each of the one or more contributors according to a dense vector embedding of the attribute of the first user and a dense vector embedding for each of the one or more contributors. In some embodiments, step 1106 includes increasing a score of a pair including the first user and a first contributor, when a number of prior content licenses between the first user and the first contributor is less than a pre-selected threshold. In some embodiments, step 1106 includes increasing a score of a pair including the first user and a first contributor, when a number of content licenses associated with the first contributor is less than a pre-selected threshold. In some embodiments, step 1106 includes increasing a score of a pair including the first user and a first contributor, when a number of content licenses associated with the first user is higher than a first threshold and a number of content licenses associated with the first contributor is lower than a second threshold.

Step 1108 includes providing, to the first user of the online content marketplace, a list of the one or more contributors ranked according to the scoring of the pairs of the first user with each of the one or more contributors.

Step 1110 includes receiving, from the first user, a selected contributor from the one or more contributors.

Step 1112 providing, to the first user, multiple content files from a gallery of the selected contributor for use in a media application running on a client device with the first user. In some embodiments, step 1112 includes providing the list in the media application, further enabling the first user to send a message, via the media application, to the one or more contributors requesting a content file.

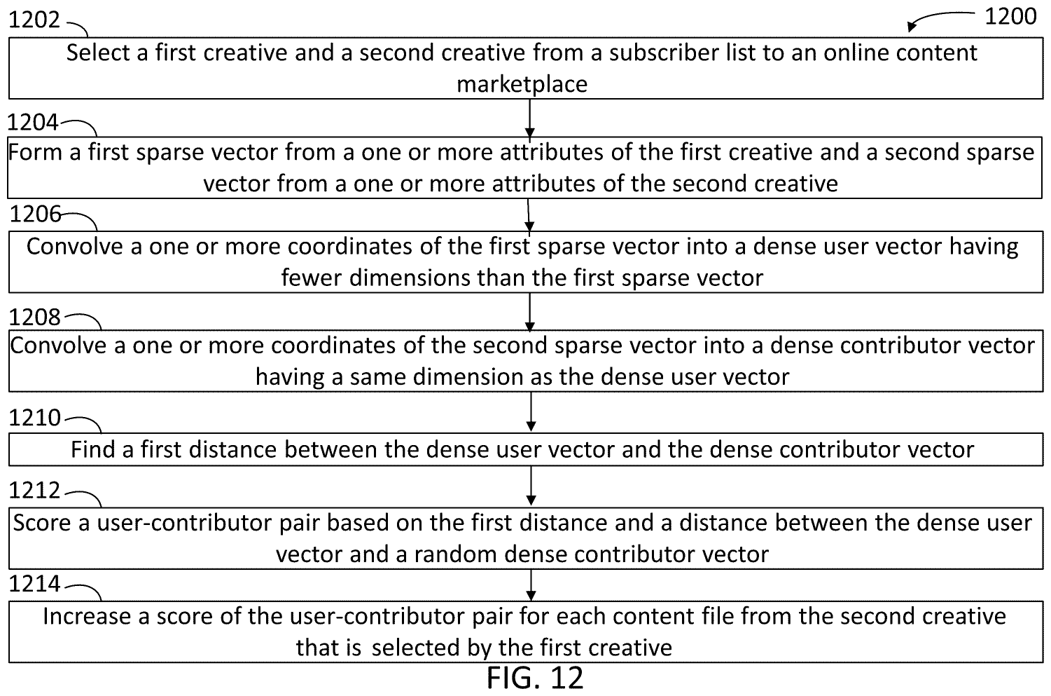

FIG. 12 is a flow chart illustrating steps in a method 1200 for training a neural network to rank user-contributor pairs in a content marketplace, according to some embodiments. At least one or more of the steps in method 1200 may be performed by a computer system in a client device or a server, the client device and the server being communicatively coupled through a network via a communications module (e.g., client device 110, server 130, network 150, and communications modules 218). The computer system may include a memory storing instructions which, when executed by a processor, perform at least partially one or more of the steps in method 1200 (e.g., processors 212 and memories 220). In some embodiments, one or more steps in method 1200 is at least partially executed by a graphic design application installed in the client device and hosted by a content marketplace engine and a creative matching engine in the server (e.g., application 222, content marketplace engine 232, and creative matching engine 234). Further, in some embodiments, one or more of the steps in method 1200 may be performed by a search tool, a license tool, a classification tool, an embedding tool, a ranking tool, a neural network tool, and a statistics tool, in the content marketplace engine and the creative matching engine (e.g., search tool 240, license tool 241, classification tool 242, embedding tool 244, ranking tool 246, neural network tool 248, and statistics tool 249). Further, in some embodiments, data and information used in, or generated by, at least one of the steps in method 1200 (e.g., a user-contributor matching recommendation history, a content licensing history, a search history) may be stored in a database communicatively coupled to, and hosted by, the server (e.g., database 252). Methods consistent with the present disclosure may include at least one or more of the steps in method 1200 performed in a different order. For example, in some embodiments, steps in method 1200 may be performed simultaneously, quasi-simultaneously, or overlapping in time.

Step 1202 includes selecting a first creative and a second creative from a subscriber list to the online content marketplace. In some embodiments, step 1202 includes selecting a user that has licensed more than a pre-selected number of content files from one or more contributors to the online content marketplace. In some embodiments, step 1202 includes selecting a contributor that has licensed more than a pre-selected number of content files to one or more users of the online content marketplace.

Step 1204 includes forming a first sparse vector from a one or more attributes of the first creative and a second sparse vector from a one or more attributes of the second creative.

Step 1206 includes convolving a one or more coordinates of the first sparse vector into a dense user vector having fewer dimensions than the first sparse vector.

Step 1208 includes convolving a one or more coordinates of the second sparse vector into a dense contributor vector having a same dimension as the dense user vector.

Step 1210 includes finding a first distance between the dense user vector and the dense contributor vector.

Step 1212 includes scoring a user-contributor pair based on the first distance and a distance between the dense user vector and a random dense contributor vector.

Step 1214 includes increasing a score of the user-contributor pair for each content file from the second creative that is selected by the first creative. In some embodiments, step 1214 includes adjusting a convolution parameter in the model to reduce the first distance between the dense user vector and the dense contributor vector. In some embodiments, step 1214 includes providing, to the first creative, a display with contributor recommendations based on a score of a pairing between the first creative and a contributor having an embedded vector separated from the dense user vector by less than a pre-selected threshold.

### Hardware Overview

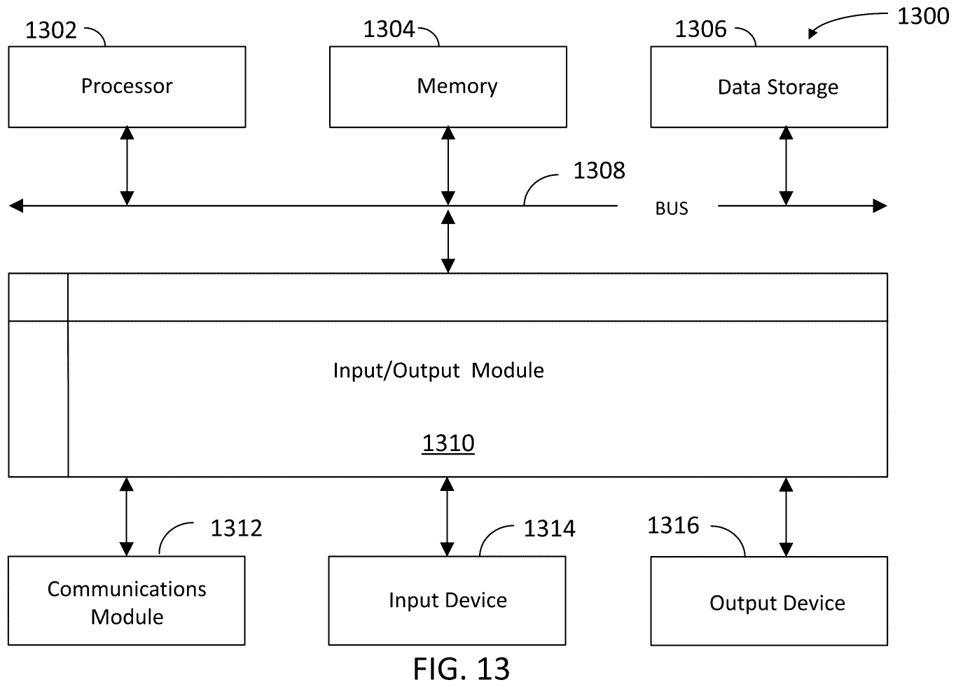

FIG. 13 is a block diagram illustrating an exemplary computer system 1300 with which the client and server of FIGS. 1 and 2, and the methods of FIGS. 11 and 12 can be implemented. In certain aspects, the computer system 1300 may be implemented using hardware or a combination of software and hardware, either in a dedicated server, or integrated into another entity, or distributed across multiple entities.

Computer system 1300 (e.g., client 110 and server 130) includes a bus 1308 or other communication mechanism for communicating information, and a processor 1302 (e.g., processors 212) coupled with bus 1308 for processing information. By way of example, the computer system 1300 may be implemented with one or more processors 1302. Processor 1302 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1300 can include, in addition to hardware, code that creates an execution environment for the computer program in question, e.g., code that constitutes processor firmware, a protocol stack, a database management system, an operating system, or a combination of one or more of them stored in an included memory 1304 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1308 for storing information and instructions to be executed by processor 1302. The processor 1302 and the memory 1304 can be supplemented by, or incorporated in, special purpose logic circuitry.

The instructions may be stored in the memory 1304 and implemented in one or more computer program products, e.g., one or more modules of computer program instructions encoded on a computer-readable medium for execution by, or to control the operation of, the computer system 1300, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 1304 may also be used for storing temporary variable or other intermediate information during execution of instructions to be executed by processor 1302.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1300 further includes a data storage device 1306 such as a magnetic disk or optical disk, coupled to bus 1308 for storing information and instructions. Computer system 1300 may be coupled via input/output module 1310 to various devices. Input/output module 1310 can be any input/output module. Exemplary input/output modules 1310 include data ports such as USB ports. The input/output module 1310 is configured to connect to a communications module 1312. Exemplary communications modules 1312 (e.g., communications modules 218) include networking interface cards, such as Ethernet cards and modems. In certain aspects, input/output module 1310 is configured to connect to a plurality of devices, such as an input device 1314 (e.g., input device 214) and/or an output device 1316 (e.g., output device 216). Exemplary input devices 1314 include a keyboard and a pointing device, e.g., a mouse or a trackball, by which a user can provide input to the computer system 1300. Other kinds of input devices 1314 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 1316 include display devices, such as an LCD (liquid crystal display) monitor, for displaying information to the user.

According to one aspect of the present disclosure, the client 110 and server 130 can be implemented using a computer system 1300 in response to processor 1302 executing one or more sequences of one or more instructions contained in memory 1304. Such instructions may be read into memory 1304 from another machine-readable medium, such as data storage device 1306. Execution of the sequences of instructions contained in main memory 1304 causes processor 1302 to perform the process steps described herein. One or more processors in a multi-processing arrangement may also be employed to execute the sequences of instructions contained in memory 1304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication tool (e.g., network 150) can include, for example, any one or more of a LAN, a WAN, the Internet, and the like. Further, the communication tool can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 1300 can include clients and servers. A client and server are generally remote from each other and typically interact through a communication network. The relationship of client and server arises by virtue of computer programs running on the respective computers and having a client-server relationship to each other. Computer system 1300 can be, for example, and without limitation, a desktop computer, laptop computer, or tablet computer. Computer system 1300 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1302 for execution. Such a medium may take many forms, including, but not limited to, non-volatile media, volatile media, and transmission media. Non-volatile media include, for example, optical or magnetic disks, such as data storage device 1306. Volatile media include dynamic memory, such as memory 1304. Transmission media include coaxial cables, copper wire, and fiber optics, including the wires forming bus 1308. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, comprising;
retrieving an attribute of a first user of an online content marketplace;
identifying a one or more contributors of the online content marketplace, based on the attribute of the first user;
scoring multiple pairs of the first user with each of the one or more contributors according to a dense vector embedding of the attribute of the first user and a dense vector embedding for each of the one or more contributors;
providing, to the first user of the online content marketplace, a list of the one or more contributors ranked according to the scoring of the pairs of the first user with each of the one or more contributors;
receiving, from the first user, a selected contributor from the one or more contributors; and
providing, to the first user, multiple content files from a gallery of the selected contributor for use in a media application running on a client device with the first user.

2. The computer-implemented method of claim 1, wherein retrieving an attribute of a user of an online content marketplace comprises retrieving a place of origin of the user, and identifying the one or more contributors of the online content marketplace comprises selecting a contributor from a same place of origin than the first user.

3. The computer-implemented method of claim 1, wherein retrieving an attribute of a user of an online content marketplace comprises retrieving a place of origin of the user, and identifying the one or more contributors of the online content marketplace comprises selecting a contributor from a ranked list of contributors provided to a second user from a same place of origin of the first user.

4. The computer-implemented method of claim 1, wherein retrieving an attribute of a user of an online content marketplace comprises retrieving a place of origin of the user, and identifying the one or more contributors of the online content marketplace comprises selecting a first contributor from a same contributor place of origin as a second contributor in a ranked list provided to a second user from a same place of origin of the first user.

5. The computer-implemented method of claim 1, wherein identifying a one or more contributors of the online content marketplace comprises selecting a contributor with whom the first user has a prior content license.

6. The computer-implemented method of claim 1, wherein scoring multiple pairs of the first user with each of the one or more contributors comprises increasing a score of a pair including the first user and a first contributor, when a number of prior content licenses between the first user and the first contributor is less than a pre-selected threshold.

7. The computer-implemented method of claim 1, wherein scoring multiple pairs of the first user with each of the one or more contributors comprises increasing a score of a pair including the first user and a first contributor, when a number of content licenses associated with the first contributor is less than a pre-selected threshold.

8. The computer-implemented method of claim 1, wherein scoring multiple pairs of the first user with each of the one or more contributors comprises increasing a score of a pair including the first user and a first contributor, when a number of content licenses associated with the first user is higher than a first threshold and a number of content licenses associated with the first contributor is lower than a second threshold.

9. The computer-implemented method of claim 1, wherein providing a list of the one or more contributors comprises including in the list a first contributor with no prior content license to the first user, wherein a score of a first user and a first contributor pair is greater than a pre-selected threshold.

10. The computer-implemented method of claim 1, wherein providing a list of the one or more contributors comprises providing the list in the media application, further enabling the first user to send a message, via the media application, to the one or more contributors requesting a content file.

11. A system, comprising:
a memory storing multiple instructions; and
one or more processors configured to execute the instructions to cause the system to perform operations, including to:
retrieve an attribute of a first user of an online content marketplace;
identify a one or more contributors of the online content marketplace, based on the attribute of the first user;
score multiple pairs of the first user with each of the one or more contributors, according to a dense vector embedding of the attribute of the first user and a dense vector embedding for each of the one or more contributors;
provide, to the first user of the online content marketplace, a list of the one or more contributors, ranked according to a score of the pairs of the first user with each of the one or more contributors;
receive, from the first user, a selected contributor from the one or more contributors; and
provide, to the first user, multiple content files from a gallery of the selected contributor for use in a media application running on a client device with the first user.

12. The system of claim 11, wherein to retrieve an attribute of a user of an online content marketplace the one or more processors execute instructions to retrieve a place of origin of the user, and to identify the one or more contributors of the online content marketplace the one or more processors execute instructions to select a contributor from a same place of origin than the first user.

13. The system of claim 11, wherein to retrieve an attribute of a user of an online content marketplace the one or more processors execute instructions to retrieve a place of origin of the user, and to identify the one or more contributors of the online content marketplace the one or more processors execute instructions to select a contributor from a ranked list of contributors provided to a second user from a same place of origin of the first user.

14. The system of claim 11, wherein to retrieve an attribute of a user of an online content marketplace the one or more processors execute instructions to retrieve a place of origin of the user, and to identify the one or more contributors of the online content marketplace the one or more processors execute instructions to select a first contributor from a same contributor place of origin as a second contributor in a ranked list provided to a second user from a same place of origin of the first user.

15. The system of claim 11, wherein to identify a one or more contributors of the online content marketplace the one or more processors execute instructions to select a contributor with whom the first user has a prior content license.

16. A method for training a model to rank creative pairs of subscribers to an online content marketplace, comprising:
selecting a first creative and a second creative from a subscriber list to the online content marketplace;
forming a first sparse vector from a one or more attributes of the first creative and a second sparse vector from a one or more attributes of the second creative;
convolving a one or more coordinates of the first sparse vector into a dense user vector having fewer dimensions than the first sparse vector;
convolving a one or more coordinates of the second sparse vector into a dense contributor vector having a same dimension as the dense user vector;
finding a first distance between the dense user vector and the dense contributor vector;
scoring a user-contributor pair based on the first distance and a distance between the dense user vector and a random dense contributor vector; and
increasing a score of the user-contributor pair for each content file from the second creative that is selected by the first creative.

17. The method of claim 16, wherein selecting the first creative comprises selecting a user that has licensed more than a pre-selected number of content files from one or more contributors to the online content marketplace.

18. The method of claim 16, wherein selecting the second creative comprises selecting a contributor that has licensed more than a pre-selected number of content files to one or more users of the online content marketplace.

19. The method of claim 16, wherein increasing a score of the user-contributor pair comprises adjusting a convolution parameter in the model to reduce the first distance between the dense user vector and the dense contributor vector.

20. The method of claim 16, further comprising providing, to the first creative, a display with contributor recommendations based on a score of a pairing between the first creative and a contributor having an embedded vector separated from the dense user vector by less than a pre-selected threshold.
